(19) United States
(12) Patent Application Publication
(10) Pub. No.: US 2004/0116702 A1
(43) Pub. Date: Jun. 17, 2004

(54) Alkoxylated acyl-and bisacylphoshine derivatives

(76) Inventors: Ralf Noe, Mannheim (DE); Andreas Henne, Neustadt (DE); Matthias Maase, Speyer (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/474,688

(22) PCT Filed: Feb. 4, 2003
(86) PCT No.: PCT/EP03/01069

(30) Foreign Application Priority Data
Feb. 13, 2002 (DE) 102 06 097.5

(51) Int. Cl. C07F 9/547

(52) U.S. Cl. 546/21; 548/111; 548/412

(57) ABSTRACT

The invention relates to acyl- or bisacylphosphine derivatives according to formula (1), wherein: Y represents O, S, NR³, N—OR³ or N—NR³R⁵⁴; Z represents O, S, NR³, N—OR³, N—NR³R⁴ or a free electron pair; Het¹ and Het², independent of one another, represent O, S and/or NR⁵, and; the other radicals have the meanings as cited in the description. The invention also relates to methods for producing these derivatives and to the use thereof.

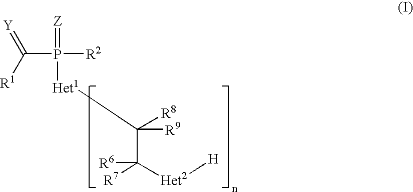

The present invention relates to alkoxylated acyl- and bisacylphosphine derivatives, to a process for their preparation, and to their use.

Acyl- and bisacylphosphine oxides and the use thereof as photoinitiators have been known for some time.

JP-A 2000-169511 discloses 2-(2-methoxyethoxy)ethyl and 2-[(2-methoxyethoxy)ethoxy]ethyl phenyl-2,4,6-trimethylbenzoyl-phosphinates (CA RN 274258-52-5 and 2742,58-53-6). These contain “capped”, alkoxylated side groups, which are not able to undergo any significant interaction with other molecules.

U.S. Pat. No. 5,362,4.19 discloses the preparation of dithiophosphoric acid derivatives in which dithiophosphoric acid esters are reacted with (meth)acrylic acid in a Michael reaction. The derivatives formed are used as lubricants. However, the specification restricts the reaction to thiophosphoric acid esters; acyl radicals on the central phosphorus atom are not described, nor is any possible use as photoinitiator.

Also known are derivatives of acylphosphine oxides which carry an unsubstituted or substituted amino group, a hydroxyl group or an —O-M⁺ group, where M⁺ is an equivalent of a cation, on the central phosphorus atom (EP-A 62 839), a C₁-C₁₂-alkoxy group (DE-A 196 50 562), an aryloxy group (EP-A 600 373) or a silyloxy group (EP-A 487 453), and which can likewise be used as photoinitiators.

Many of the photoinitiators used hitherto have the problem that residues or degradation products of photoinitiators are able to diffuse out of the cured coating into the surrounding medium (migration), where they can cause problems, for example if the medium is a packaging material for foods.

Furthermore, the low solubility and incorporation ability of certain phosphine oxides are limited, which means that there continues to be a demand for other phosphine oxides having improved interactions for radiation-curable surface-coating systems.

EP-B 7 508 discloses the synthesis of acylphosphine oxides containing alkoxy-groups on the central phosphorus atom in an Arbusov rearrangement by reaction of alkoxyphosphines and acid chlorides:

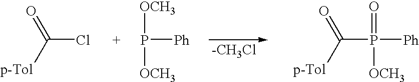

where p-Tol=4-methylphenyl, and Ph=phenyl.

In JP-A 2000-169511, the “capped” alkoxylated side groups mentioned at the outset were introduced via the relevant alkoxyphosphines. The introduction of side groups carrying functional groups is not possible in this way since they would react, for example, with acid chlorides.

This synthesis is thus restricted in its substrates, and the products can only be varied within narrow limits.

It is an object of the present invention to provide compounds which enable the synthesis of novel acyl- and bisacylphosphine oxides and can themselves likewise be employed as photoinitiators which migrate to only a very small extent.

We have found that this object is achieved by acyl- or bisacylphosphine derivatives of the formula (I)

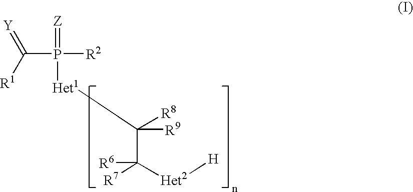

where

R¹ and R² are C₁-C₁₈-alkyl, or C₂-C₁₈-alkyl, C₂-C₁₈-alkenyl, C₆-C₁₂-aryl or C₅-C₁₂-cycloalkyl, each of which is uninterrupted or interrupted by one or more oxygen and/or sulfur atoms and/or one or more substituted or unsubstituted imino groups, or are a five- to six-membered, oxygen, nitrogen and/or sulfur atom-containing heterocyclic radical, where the said radicals may each be substituted by aryl, alkyl, aryloxy, alkoxy, heteroatoms and/or heterocyclic radicals,

R² is furthermore C₁- C₁₈-alkoxy, which is unsubstituted or substituted by aryl, alkyl, aryloxy, alkoxy, heteroatoms and/or heterocyclic radicals, or is R¹—(C═Y)—,

Y is O, S, NR³, N—OR³ or N—NR³R⁴,

Z is O, S, NR³, N—OR³, N—NR³R⁴ or a free pair of electrons,

R³ is hydrogen, C₁- to C₄-alkyl, SO₃H, phenyl or acetyl,

R⁴ is hydrogen, C₁- to C₄-alkyl, COOR³, or C₆-C₁₂-aryl or arylsulfonyl, each of which is unsubstituted or substituted by aryl, alkyl, aryloxy, alkoxy, heteroatoms and/or heterocyclic radicals,

Het¹ and Het², independently of one another, are O, S and/or NR⁵,

R⁵ is hydrogen, C₃-C₁₈-alkyl, which is unsubstituted or substituted by aryl, alkyl, aryloxy, alkoxy, heteroatoms and/or heterocyclic radicals, or C₆-C₁₂-aryl, which is unsubstituted or substituted by aryl, alkyl, aryloxy, alkoxy, heteroatoms and/or heterocyclic radicals,

R⁶, R⁷, R⁸ and R⁹, independently of one another, are hydrogen, C₁-C₁₈-alkyl, which is unsubstituted or substituted by aryl, alkyl, aryloxy, alkoxy, heteroatoms and/or heterocyclic radicals, C₂-C₁₈-alkenyl, which is unsubstituted or substituted by aryl, alkyl, aryloxy, alkoxy, heteroatoms and/or heterocyclic radicals, or C₆-C₁₂-aryl, which is unsubstituted or substituted by aryl, alkyl, aryloxy, alkoxy, heteroatoms and/or heterocyclic radicals, and

n is an integer from 1 to 100.

In these formulae,

C₁-C₁₈-alkyl which is unsubstituted or substituted by aryl, alkyl, aryloxy, alkoxy, heteroatoms and/or heterocyclic radicals is, for example, methyl, ethyl, propyl, isopropyl, n-butyl, sec-butyl, tert-butyl, pentyl, hexyl, heptyl, octyl,

2-ethylhexyl, 2,4,4-trimethylpentyl, decyl, dodecyl, tetradecyl, heptadecyl, octadecyl, 1,1-dimethylpropyl, 1,1-dimethylbutyl,

1,1,3,3-tetramethylbutyl, benzyl, 1-phenylethyl, 2-phenylethyl,

α,α-dimethylbenzyl, benzhydryl, p-tolylmethyl,

1-(p-butylphenyl)-ethyl, p-chlorobenzyl, 2,4-dichlorobenzyl, p-methoxybenzyl, m-ethoxybenzyl, 2-cyanoethyl, 2-cyanopropyl,

2-methoxycarbonethyl, 2-ethoxycarbonylethyl,

2-butoxycarbonylpropyl, 1,2-di-(methoxycarbonyl)ethyl,

2-methoxyethyl, 2-ethoxyethyl, 2-butoxyethyl, diethoxymethyl, diethoxyethyl, 1,3-dioxolan-2-yl, 1,3-dioxan-2-yl,

2-methyl-1,3-dioxolan-2-yl, 4-methyl-1,3-dioxolan-2-yl,

2-isopropoxyethyl, 2-butoxypropyl, 2-octyloxyethyl, chloromethyl,

2-chloroethyl, trichloromethyl, trifluoromethyl,

1,1-dimethyl-2-chloroethyl, 2-methoxyisopropyl, 2-ethoxyethyl, butylthiomethyl, 2-dodecylthioethyl, 2-phenylthioethyl,

2,2,22-trifluoroethyl, 2-hydroxyethyl, 2-hydroxypropyl,

3-hydroxypropyl, 4-hydroxybutyl, 6-hydroxyhexyl, 2-aminoethyl,

2-aminopropyl, 3-aminopropyl, 4-aminobutyl, 6-aminohexyl,

2-methylaminoethyl, 2-methylaminopropyl, 3-methylaminopropyl,

4-methylaminobutyl, 6-methylaminohexyl, 2-dimethylaminoethyl,

2-dimethylaminopropyl, 3-dimethylaminopropyl,

4-dimethylaminobutyl, 6-dimethylaminohexyl,

2-hydroxy-2,2-dimethylethyl, 2-phenoxyethyl, 2-phenoxypropyl,

3-phenoxypropyl, 4-phenoxybutyl, 6-phenoxyhexyl, 2-methoxyethyl,

2-methoxypropyl, 3-methoxypropyl, 4-methoxybutyl, 6-methoxyhexyl,

2-ethoxyethyl, 2-ethoxypropyl, 3-ethoxypropyl, 4-ethoxybutyl or 6-ethoxyhexyl,

C₁-C₁₈-alkoxy which is unsubstituted or substituted by aryl, alkyl, aryloxy, alkoxy, heteroatoms and/or heterocyclic radicals is, for example, methoxy, ethoxy, n-propoxy, iso-propoxy, n-butoxy, iso-butoxy, sec-butoxy, tert-butoxy,

6-hydroxy-1,4-dioxohexyl, 9-hydroxy-1,4,7-trioxononyl,

12-hydroxy-1,4,7,10-tetraoxododecyl, 6-methoxy-1,4-dioxohexyl,

9-methoxy-1,4,7-trioxononyl, 12-methoxy-1,4,7,10-tetraoxododecyl,

6-ethoxy-1,4-dioxohexyl, 9-ethoxy-1,4,7-trioxononyl,

12-ethoxy-1,4,7,10-tetraoxododecyl, 8-hydroxy-1,5-dioxooctyl,

12-hydroxy-1,5,9-trioxooctyl,

16-hydroxy-1,5,9,13-tetraoxohexadecyl, 8-methoxy-1,5-dioxooctyl,

12-methoxy-1,5,9-trioxooctyl,

16-methoxy-1,5,9,13-tetraoxohexadecyl, 8-ethoxy-1,5-dioxooctyl,

12-ethoxy-1,5,9-trioxooctyl,

16-ethoxy-1,5,9,13-tetraoxohexadecyl, 10-hydroxy-1,6-dioxodecyl,

15-hydroxy-1,6,11-trioxopentadecyl, 10-methoxy-1,6-dioxodecyl,

15-methoxy-1,6,11-trioxopentadecyl, 10-ethoxy-1,6-dioxodecyl or 15-ethoxy-1,6,11-trioxopentadecyl,

C₂-C₁₈-alkyl which is uninterrupted or interrupted by one or more oxygen and/or sulfur atoms and/or one or more substituted or unsubstituted imino groups is, for example,

5-hydroxy-3-oxapentyl, 8-hydroxy-3,6-dioxaoctyl,

11-hydroxy-3,6,9-trioxaundecyl, 7-hydroxy-4-oxaheptyl,

11-hydroxy-4,8-dioxaundecyl, 15-hydroxy-4,8,12-trioxapentadecyl,

9-hydroxy-5-oxanonyl, 14-hydroxy-5,10-oxatetradecyl,

5-methoxy-3-oxapentyl, 8-methoxy-3,6-dioxaoctyl,

11-methoxy-3,6,9-trioxaundecyl, 7-methoxy-4-oxaheptyl,

11-methoxy-4,8-dioxaundecyl, 15-methoxy-4,-8,12-trioxapentadecyl,

9-methoxy-5-oxanonyl, 14-methoxy-5,10-oxatetradecyl,

5-ethoxy-3-oxapentyl, 8-ethoxy-3,6-dioxaoctyl,

11-ethoxy-3,6,9-trioxaundecyl, 7-ethoxy-4-oxaheptyl,

11-ethoxy-4,8-dioxaundecyl, 15-ethoxy-4,8,12-trioxapentadecyl,

9-ethoxy-5-oxanonyl or 14-ethoxy-5,10-oxatetradecyl.

The number of oxygen atoms and/or sulfur atoms and/or imino groups is unrestricted. In general, it is not more than 5 in the radical, preferably not more than 4 and very particularly preferably not more than 3.

Furthermore, at least one carbon atom, preferably at least two carbon atoms, are located between two heteroatoms.

Substituted and unsubstituted imino groups can be, for example, imino, methylimino, iso-propylimino, n-butylimino or tert-butylimino.

Furthermore,

C₂-C₁₈-alkenyl which is unsubstituted or substituted by aryl, 35 alkyl, aryloxy, alkoxy, heteroatoms and/or heterocyclic radicals is, for example, vinyl, 1-propenyl, allyl, methallyl,

1,1-dimethylallyl, 2-butenyl, 2-hexenyl, octenyl, undecenyl,

dodecenyl, octadecenyl, 2-phenylvinyl, 2-methoxyvinyl,

2-ethoxyvinyl, 2-methoxyallyl, 3-methoxyallyl, 2-ethoxyallyl,

3-ethoxyallyl or 1- or 2-chlorovinyl,

C₆-C₁₂-aryl which is unsubstituted or substituted by aryl, alkyl, aryloxy, alkoxy, heteroatoms and/or heterocyclic radicals is, for example, phenyl, tolyl, xylyl, α-naphthyl, β-naphthyl,

4-biphenylyl, chlorophenyl, dichlorophenyl, trichlorophenyl,

difluorophenyl, methylphenyl, dimethylphenyl, trimethylphenyl,

ethylphenyl, diethylphenyl, iso-propylphenyl, tert-butylphenyl,

dodecylphenyl, methoxyphenyl, dimethoxyphenyl, ethoxyphenyl,

hexyloxyphenyl, methylnaphthyl, isopropylnaphthyl,

chloronaphthyl, ethoxynaphthyl, 2,6-dimethylphenyl,

2,4,6-trimethylphenyl, 2,6-dimethoxyphenyl, 2,6-dichlorophenyl,

4-bromophenyl, 2- or 4-nitrophenyl, 2,4- or 2,6-dinitrophenyl,

4-dimethylaminophenyl, 4-acetylphenyl, methoxyethylphenyl or ethoxymethylphenyl,

C₅-C₁₂-cycloalkyl which is unsubstituted or substituted by aryl, alkyl, aryloxy, alkoxy, heteroatoms and/or heterocyclic radicals is, for example, cyclopentyl, cyclohexyl, cyclooctyl,

cyclododecyl, methylcyclopentyl, dimethylcyclopentyl,

methylcyclohexyl, dimethylcyclohexyl, diethylcyclohexyl,

butylcyclohexyl, methoxycyclohexyl, dimethoxycyclohexyl,

diethoxycyclohexyl, butylthiocyclohexyl, chlorocyclohexyl,

dichlorocyclohexyl, dichlorocyclopentyl and a saturated or unsaturated bicyclic system, for example norbornyl or norbornenyl,

a five- to six-membered, oxygen, nitrogen and/or sulfur atom-containing heterocyclic radical is, for example, furyl,

thiophenyl, pyrryl, pyridyl, indolyl, benzoxazolyl, dioxolyl,

dioxyl, benzimidazolyl, benzothiazolyl, dimethylpyridyl,

methylquinolyl, dimethylpyrryl, methoxyfuryl, dimethoxypyridyl,

difluoropyridyl, methylthiophenyl, isopropylthiophenyl or tert-butylthiophenyl,

C₁ to C₄-alkyl is, for example, methyl, ethyl, propyl, isopropyl, n-butyl, sec-butyl or tert-butyl, and

C₆-C₁₂-aryl or arylsulfonyl, each of which is unsubstituted or substituted by aryl, alkyl, aryloxy, alkoxy, heteroatoms and/or

heterocyclic radicals, is, for example, phenyl,

2,6-dinitrophenyl, 2,4-dinitrophenyl, 2-nitrophenyl,

4-nitrophenyl, formyl, acetyl, propionyl, carbamoyl,

phenylsulfonyl or 4-methylphenylsulfonyl.

The number of substituents in the stated radicals is unrestricted. In general, it is up to 3 substituents, preferably up to 2 substituents and particularly preferably up to one substituent, in radicals having from one to three carbon atoms. In radicals having from four to six carbon atoms, it is generally up to 4 substituents, preferably up to 3 substituents and particularly preferably up to one substituent. In radicals having more than seven carbon atoms, it is generally up to 6 substituents, preferably up to 4 substituents and particularly preferably up to two substituents.

R¹ is preferably phenyl, tolyl, xylyl, α-naphthyl, β-naphthyl, 2-, 3- or 4-chlorophenyl, 2,6- or 2,4-dichlorophenyl,

2,4,6-trichlorophenyl, 2-, 3- or 4-methylphenyl, 2,6- or

2,4-dimethylphenyl, 2,4,6-trimethylphenyl, 2-, 3- or

4-ethylphenyl, 2,6- or 2,4-diethylphenyl, 2-, 3- or

4-iso-propylphenyl, 2-, 3- or 4-tert-butylphenyl, 2-, 3- or

4-methoxyphenyl, 2,6- or 2,4-dimethoxyphenyl, 2,6- or

2,4-diethoxyphenyl, methylnaphthyl, 2,6-dimethylphenyl,

2,4,6-trimethylphenyl, 2,6-dimethoxyphenyl, 2,6-dichlorophenyl,

4-bromophenyl, 2- or 4-nitrophenyl, 2,4- or 2,6-dinitrophenyl,

4-dimethylaminophenyl, 4-acetylphenyl, cyclopentyl, cyclohexyl,

2,5-dimethylcyclopentyl, 2,6-dimethylcyclohexyl,

2,6-diethylcyclohexyl, 2,6-dimethoxycyclohexyl,

2,6-diethoxycyclohexyl, 2,6-dichlorocyclohexyl,

2,5-dichlorocyclopentyl, 2- or 3-furyl, 2- or 3-thiophenyl, 2- or

3-pyrryl, dimethylpyrryl or ortho-substituted phenyls, such as

2-methylphenyl, 2-methoxyphenyl or 2-chlorophenyl.

R¹ is particularly preferably phenyl, tolyl, α-naphthyl,

β-naphthyl, 2,6- or 2,4-dichlorophenyl, 2,4,6-trichlorophenyl,

2,6- or 2,4-dimethylphenyl, 2,4,6-trimethylphenyl, 2,6- or

2,4-diethylphenyl, 2-iso-propylphenyl, 2-tert-butylphenyl, 2,6- or

2,4-dimethoxyphenyl, 2,6- or 2,4-diethoxyphenyl,

methylnaphthyl, 2,6-dimethylphenyl, 2,4,6-trimethylphenyl,

2,6-dimethoxyphenyl, 2,6-dichlorophenyl, 2,6-dinitrophenyl,

2,5-dimethylcyclopentyl, 2,6-dimethylcyclohexyl,

2,6-diethylcyclohexyl, 2,6-dimethoxycyclohexyl,

2,6-diethoxycyclohexyl, 2,6-dichlorocyclohexyl,

2,5-dichlorocyclopentyl or ortho-substituted phenyls, such as

2-methylphenyl, 2-methoxyphenyl or 2-chlorophenyl.

R¹ is very particularly preferably phenyl, α-naphthyl,

2,6-dichlorophenyl, 2,4,6-trichlorophenyl, 2,6-dimethylphenyl,

2,4,6-trimethylphenyl, 2,6-diethylphenyl, 2,6-dimethoxyphenyl,

2,6-diethoxyphenyl, 2,6-dimethylphenyl, 2,4,6-trimethylphenyl,

2,6-dimethoxyphenyl, 2,6-dichlorophenyl, 2,6-dinitrophenyl,

2,6-dimethylcyclohexyl, 2,6-diethylcyclohexyl,

2,6-dimethoxycyclohexyl, 2,6-diethoxycyclohexyl or

2,6-dichlorocyclohexyl.

R¹ is in particular phenyl, 2,6-dichlorophenyl, 2,4,6-trichlorophenyl, 2,6-dimethylphenyl, 2,4,6-trimethylphenyl or 2,6-dimethoxyphenyl.

R² is preferably 2,4,4-trimethylpentyl, benzyl, p-chlorobenzyl,

2,4-dichlorobenzyl, p-methoxybenzyl, methoxy, ethoxy, n-propoxy,

iso-propoxy, n-butoxy, iso-butoxy, sec-butoxy, tert-butoxy,

6-hydroxy-1,4-dioxohexyl, 9-hydroxy-1,4,7-trioxononyl,

12-hydroxy-1,4,7,10-tetraoxododecyl, 6-methoxy-1,4-dioxohexyl,

9-methoxy-1,4,7-trioxononyl, 12-methoxy-1,4,7,10-tetraoxododecyl,

6-ethoxy-1,4-dioxohexyl, 9-ethoxy-1,4,7-trioxononyl,

12-ethoxy-1,4,7,10-tetraoxododecyl, 8-hydroxy-1,5-dioxooctyl,

12-hydroxy-1,5,9-trioxooctyl, 16-hydroxy-1,5:,9,13-tetraoxohexadecyl,

10-hydroxy-1,6-dioxodecyl,

15-hydroxy-1,6,11-trioxopentadecyl, vinyl, 1-propenyl, allyl,

methallyl, 1,1-dimethylallyl, 2-butenyl, 2-hexenyl,

2-phenylvinyl, 2-methoxyvinyl, 2-ethoxyvinyl, 2-chlorovinyl,

phenyl, tolyl, xylyl, α-naphthyl, β-naphthyl, 4-biphenylyl, 2-,

3- or 4-chlorophenyl, 2,4- or 2,6-dichlorophenyl,

2,4,6-trichlorophenyl, 2-, 3- or 4-methylphenyl, 2,4- or

2,6-dimethylphenyl, 2,4,6-trimethylphenyl, 2-, 3- or

4-ethylphenyl, 2,4- or 2,6-diethylphenyl, 2-, 3- or

4-iso-propylphenyl, 2-, 3- or 4-tert-butylphenyl, 2-, 3- or

4-methoxyphenyl, 2,4- or 2,6-dimethoxyphenyl, 2-, 3- or

4-ethoxyphenyl, methylnaphthyl, chloronaphthyl, ethoxynaphthyl,

2,6-dimethylphenyl, 2,4,6-trimethylphenyl, 2,4- or

2,6-dimethoxyphenyl, 2,4- or 2,6-dichlorophenyl, 2- or

4-nitrophenyl, 2,4- or 2,6.-dinitrophenyl, 4-dimethylaminophenyl,

4-acetylphenyl or R¹—(C═Y)—.

R² is particularly preferably benzyl, p-chlorobenzyl,

2,4-dichlorobenzyl, p-methoxybenzyl, methoxy, ethoxy, n-propoxy,

iso-propoxy, n-butoxy, iso-butoxy, sec-butoxy, tert-butoxy,

6-hydroxy-1,4-dioxohexyl, 9-hydroxy-1,4,7-trioxononyl,

12-hydroxy-1,4,7,10-tetraoxododecyl, 6-methoxy-1,4-dioxohexyl,

9-methoxy-1,4,7-trioxononyl, 12-methoxy-1,4,7,10-tetraoxododecyl,

6-ethoxy-1,4-dioxohexyl, 9-ethoxy-1,4,7-trioxononyl,

12-ethoxy-1,4,7,10-tetraoxododecyl, 8-hydroxy-1,5-dioxooctyl,

12-hydroxy-1,5,9-trioxooctyl, 16-hydroxy-1,5,9,13-tetraoxohexadecyl,

10-hydroxy-1,6-dioxodecyl,

15-hydroxy-1,6,11-trioxopentadecyl, vinyl, 2-butenyl,

2-phenylvinyl, phenyl, tolyl, xylyl, α-naphthyl, β-naphthyl,

4-biphenylyl, 2-, 3- or 4-chlorophenyl, 2,4- or

2,6-dichlorophenyl, 2,4,6-trichlorophenyl, 2-, 3- or

4-methylphenyl, 2,4- or 2,6-dimethylphenyl,

2,4,6-trimethylphenyl, 2-, 3- or 4-ethylphenyl, 2-, 3- or

4-iso-propylphenyl, 2-, 3- or 4-tert-butylphenyl, 2-, 3- or

4-methoxyphenyl, 2,4- or 2,6-dimethoxyphenyl, 2-, 3- or

4-ethoxyphenyl, methylnaphthyl, chloronaphthyl, ethoxynaphthyl,

2- or 4-nitrophenyl, 2,4- or 2,6-dinitrophenyl,

4-dimethylaminophenyl, 4-acetylphenyl or R¹—(C═Y)—.

R² is very particularly preferably methoxy, ethoxy, n-propoxy,

iso-propoxy, n-butoxy, sec-butoxy, iso-butoxy, tert-butoxy,

6-hydroxy-1,4-dioxohexyl, 9-hydroxy-1,4,7-trioxononyl,

12-hydroxy-1,4,7,10-tetraoxododecyl, 8-hydroxy-1,5-dioxooctyl,

12-hydroxy-1,5,9-trioxooctyl, 16-hydroxy-1,5,9,13-tetraoxohexadecyl,

10-hydroxy-1,6-dioxodecyl,

15-hydroxy-1,6,11-trioxopentadecyl, phenyl, xylyl, α-naphthyl, β-naphthyl, 4-biphenylyl, 2-, 3- or 4-chlorophenyl,

2,4-dichlorophenyl, 2-, 3- or 4-methylphenyl, 2,4-dimethylphenyl,

2-, 3- or 4-ethylphenyl, 2-, 3- or 4-methoxyphenyl,

2,4-dimethoxyphenyl, 2-, 3- or 4-ethoxyphenyl, methylnaphthyl,

chloronaphthyl, ethoxynaphthyl, 2- or 4-nitrophenyl or R¹—(C═Y)—.

R² is in particular methoxy, ethoxy, n-propoxy, iso-propoxy,

n-butoxy, sec-butoxy, iso-butoxy, tert-butoxy, phenyl,

4-biphenylyl, 2-, 3- or 4-chlorophenyl, 2-, 3- or 4-methylphenyl,

2-, 3- or 4-methoxyphenyl or 2-, 3- or 4-ethoxyphenyl. R² is especially phenyl, methoxy or ethoxy.

Y is preferably O, S or NR³.

Y is particularly preferably O or S and very particularly preferably O.

Z is preferably O, S , NR³ or a free pair of electrons, particularly preferably O, S or a free pair of electrons, very 30 particularly preferably O or a free pair of electrons and in particular O.

R³ is preferably hydrogen, methyl, tert-butyl, phenyl or SO₃H, particularly preferably hydrogen, tert-butyl, phenyl or SO₃H and very particularly preferably hydrogen, tert-butyl or phenyl.

R⁴ is preferably hydrogen, methyl, phenyl, 2,4-dinitrophenyl, carbamoyl, phenylsulfonyl or 4-methylphenylsulfonyl, particularly preferably hydrogen, phenyl, 2,4-dinitrophenyl or phenylsulfonyl, very particularly preferably hydrogen, 2,4-dinitrophenyl or phenylsulfonyl and in particular hydrogen or 2,4-dinitrophenyl.

Het¹ is preferably O or NR⁵ and particularly preferably O.

Het² is preferably O or NR⁵ and particularly preferably O.

R⁵ is preferably hydrogen, methyl, ethyl, n-propyl, n-butyl, tert-butyl or phenyl, particularly preferably hydrogen, methyl or tert-butyl and very particularly preferably hydrogen.

R⁶, R⁷, R⁸ and R⁹, independently of one another, are preferably hydrogen, methyl, ethyl, n-butyl, n-hexyl, methoxy, ethoxy, n-butoxy, phenyl, 4-methylphenyl, 2-, 3- or 4-methoxyphenyl, 2-, 3- or 4-chlorophenyl or vinyl.

R⁶, R⁷, R⁸ and R⁹, independently of one another, are particularly preferably hydrogen, methyl, phenyl or vinyl.

R⁶, R⁷, R⁸ and R⁹, independently of one another, are very particularly preferably hydrogen or methyl and in particular hydrogen.

n is preferably from 1 to 50, particularly preferably from 1 to 40, very particularly preferably from 1 to 20 and especially from 2 to 10.

of the compounds described by the formula (I), particular preference is given to the following species I-1 to I-180, in which the radicals in the formula (I) have the following meanings:

| | | | | | | | | | | | |
|---|---|---|---|---|---|---|---|---|---|---|---|
| I- | R¹ | R² | Y | Z | R⁶ | R⁷ | R⁸ | R⁹ | Het¹ | Het² | n |

| | | | | | | | | | | | |
|---|---|---|---|---|---|---|---|---|---|---|---|
| 1 | TMP | Ph | O | O | H | H | H | H | O | O | 1 |
| 2 | TMP | Ph | O | O | CH₃ | H | H | H | O | O | 1 |
| 3 | TMP | Ph | O | O | H | H | CH₃ | H | O | O | 1 |
| 4 | TMP | Ph | O | O | CH₃ | CH₃ | H | H | O | O | 1 |
| 5 | TMP | Ph | O | O | H | H | CH₃ | CH₃ | O | O | 1 |
| 6 | TMP | Ph | O | O | Vinyl | H | H | H | O | O | 1 |
| 7 | TMP | Ph | O | O | Ph | H | H | H | O | O | 1 |
| 8 | TMP | Ph | O | O | H | H | H | H | N | O | 1 |
| 9 | TMP | Ph | O | O | CH₃ | H | H | H | N | O | 1 |
| 10 | TMP | Ph | O | O | H | H | CH₃ | H | N | O | 1 |
| 11 | TMP | Ph | O | O | H | H | H | H | O | N | 1 |
| 12 | TMP | Ph | O | O | H | H | H | H | O | N | 1 |
| 13 | TMP | Ph | O | O | H | H | H | H | O | O | 2 |
| 14 | TMP | Ph | O | O | CH₃ | H | H | H | O | O | 2 |
| 15 | TMP | Ph | O | O | H | H | CH₃ | H | O | O | 2 |
| 16 | TMP | Ph | O | O | CH₃ | CH₃ | H | H | O | O | 2 |
| 17 | TMP | Ph | O | O | H | H | CH₃ | CH₃ | O | O | 2 |
| 18 | TMP | Ph | O | O | Vinyl | H | H | H | O | O | 2 |
| 19 | TMP | Ph | O | O | Ph | H | H | H | O | O | 2 |
| 20 | TMP | Ph | O | O | H | H | H | H | N | O | 2 |
| 21 | TMP | Ph | O | O | CH₃ | H | H | H | N | O | 2 |
| 22 | TMP | Ph | O | O | H | H | CH₃ | H | N | O | 2 |
| 23 | TMP | Ph | O | O | H | H | H | H | O | N | 2 |
| 24 | TMP | Ph | O | O | H | H | H | H | O | N | 2 |
| 25 | TMP | Ph | O | O | H | H | H | H | O | O | 3 |
| 26 | TMP | Ph | O | O | CH₃ | H | H | H | O | O | 3 |
| 27 | TMP | Ph | O | O | H | H | CH₃ | H | O | O | 3 |
| 28 | TMP | Ph | O | O | CH₃ | CH₃ | H | H | O | O | 3 |
| 29 | TMP | Ph | O | O | H | H | CH₃ | CH₃ | O | O | 3 |
| 30 | TMP | Ph | O | O | Vinyl | H | H | H | O | O | 3 |
| 31 | TMP | Ph | O | O | Ph | H | H | H | O | O | 3 |
| 32 | TMP | Ph | O | O | H | H | H | H | N | O | 3 |
| 33 | TMP | Ph | O | O | CH₃ | H | H | H | N | O | 3 |
| 34 | TMP | Ph | O | O | H | H | CH₃ | H | N | O | 3 |
| 35 | TMP | Ph | O | O | H | H | H | H | O | N | 3 |
| 36 | TMP | Ph | O | O | H | H | H | H | O | N | 3 |
| 37 | TMP | Ph | O | O | H | H | H | H | O | O | 5 |
| 38 | TMP | Ph | O | O | CH₃ | H | H | H | O | O | 5 |
| 39 | TMP | Ph | O | O | H | H | CH₃ | H | O | O | 5 |
| 40 | TMP | Ph | O | O | CH₃ | CH₃ | H | H | O | O | 5 |
| 41 | TMP | Ph | O | O | H | H | CH₃ | CH₃ | O | O | 5 |
| 42 | TMP | Ph | O | O | Vinyl | H | H | H | O | O | 5 |
| 43 | TMP | Ph | O | O | Ph | H | H | H | O | O | 5 |
| 44 | TMP | Ph | O | O | H | H | H | H | N | O | 5 |
| 45 | TMP | Ph | O | O | CH₃ | H | H | H | N | O | 5 |
| 46 | TMP | Ph | O | O | H | H | CH₃ | H | N | O | 5 |
| 47 | TMP | Ph | O | O | H | H | H | H | O | N | 5 |
| 48 | TMP | Ph | O | O | H | H | H | H | O | N | 5 |
| 49 | TMP | Ph | O | O | H | H | H | H | O | O | 10 |
| 50 | TMP | Ph | O | O | CH₃ | H | H | H | O | O | 10 |
| 51 | TMP | Ph | O | O | H | H | CH₃ | H | O | O | 10 |
| 52 | TMP | Ph | O | O | CH₃ | CH₃ | H | H | O | O | 10 |
| 53 | TMP | Ph | O | O | H | H | CH₃ | CH₃ | O | O | 10 |
| 54 | TMP | Ph | O | O | Vinyl | H | H | H | O | O | 10 |
| 55 | TMP | Ph | O | O | Ph | H | H | H | O | O | 10 |
| 56 | TMP | Ph | O | O | H | H | H | H | N | O | 10 |
| 57 | TMP | Ph | O | O | CH₃ | H | H | H | N | O | 10 |
| 58 | TMP | Ph | O | O | H | H | CH₃ | H | N | O | 10 |
| 59 | TMP | Ph | O | O | H | H | H | H | O | N | 10 |
| 60 | TMP | Ph | O | O | H | H | H | H | O | N | 10 |
| 61 | TMP | OEt | O | O | H | H | H | H | O | O | 1 |
| 62 | TMP | OEt | O | O | CH₃ | H | H | H | O | O | 1 |
| 63 | TMP | OEt | O | O | H | H | CH₃ | H | O | O | 1 |
| 64 | TMP | OEt | O | O | CH₃ | CH₃ | H | H | O | O | 1 |
| 65 | TMP | OEt | O | O | H | H | CH₃ | CH₃ | O | O | 1 |
| 66 | TMP | OEt | O | O | Vinyl | H | H | H | O | O | 1 |
| 67 | TMP | OEt | O | O | Ph | H | H | H | O | O | 1 |
| 68 | TMP | OEt | O | O | H | H | H | H | N | O | 1 |
| 69 | TMP | OEt | O | O | CH₃ | H | H | H | N | O | 1 |
| 70 | TMP | OEt | O | O | H | H | CH₃ | H | N | O | 1 |
| 71 | TMP | OEt | O | O | H | H | H | H | O | N | 1 |
| 72 | TMP | OEt | O | O | H | H | H | H | O | N | 1 |
| 73 | TMP | OEt | O | O | H | H | H | H | O | O | 2 |
| 74 | TMP | OEt | O | O | CH₃ | H | H | H | O | O | 2 |
| 75 | TMP | OEt | O | O | H | H | CH₃ | H | O | O | 2 |
| 76 | TMP | OEt | O | O | CH₃ | CH₃ | H | H | O | O | 2 |
| 77 | TMP | OEt | O | O | H | H | CH₃ | CH₃ | O | O | 2 |
| 78 | TMP | OEt | O | O | Vinyl | H | H | H | O | O | 2 |
| 79 | TMP | OEt | O | O | Ph | H | H | H | O | O | 2 |
| 80 | TMP | OEt | O | O | H | H | H | H | N | O | 2 |
| 81 | TMP | OEt | O | O | CH₃ | H | H | H | N | O | 2 |
| 82 | TMP | OEt | O | O | H | H | CH₃ | H | N | O | 2 |
| 83 | TMP | OEt | O | O | H | H | H | H | O | N | 2 |
| 84 | TMP | OEt | O | O | H | H | H | H | O | N | 2 |
| 85 | TMP | OEt | O | O | H | H | H | H | O | O | 3 |
| 86 | TMP | OEt | O | O | CH₃ | H | H | H | O | O | 3 |
| 87 | TMP | OEt | O | O | H | H | CH₃ | H | O | O | 3 |
| 88 | TMP | OEt | O | O | CH₃ | CH₃ | H | H | O | O | 3 |
| 89 | TMP | OEt | O | O | H | H | CH₃ | CH₃ | O | O | 3 |
| 90 | TMP | OEt | O | O | Vinyl | H | H | H | O | O | 3 |
| 91 | TMP | OEt | O | O | Ph | H | H | H | O | O | 3 |
| 92 | TMP | OEt | O | O | H | H | H | H | N | O | 3 |
| 93 | TMP | OEt | O | O | CH₃ | H | H | H | N | O | 3 |
| 94 | TMP | OEt | O | O | H | H | CH₃ | H | N | O | 3 |
| 95 | TMP | OEt | O | O | H | H | H | H | O | N | 3 |
| 96 | TMP | OEt | O | O | H | H | H | H | O | N | 3 |
| 97 | TMP | OEt | O | O | H | H | H | H | O | O | 5 |
| 98 | TMP | OEt | O | O | CH₃ | H | H | H | O | O | 5 |
| 99 | TMP | OEt | O | O | H | H | CH₃ | H | O | O | 5 |
| 100 | TMP | OEt | O | O | CH₃ | CH₃ | H | H | O | O | 5 |
| 101 | TMP | OEt | O | O | H | H | CH₃ | CH₃ | O | O | 5 |
| 102 | TMP | OEt | O | O | Vinyl | H | H | H | O | O | 5 |
| 103 | TMP | OEt | O | O | Ph | H | H | H | O | O | 5 |
| 104 | TMP | OEt | O | O | H | H | H | H | N | O | 5 |
| 105 | TMP | OEt | O | O | CH₃ | H | H | H | N | O | 5 |
| 106 | TMP | OEt | O | O | H | H | CH₃ | H | N | O | 5 |
| 107 | TMP | OEt | O | O | H | H | H | H | O | N | 5 |
| 108 | TMP | OEt | O | O | H | H | H | H | O | N | 5 |
| 109 | TMP | OEt | O | O | H | H | H | H | O | O | 10 |
| 110 | TMP | OEt | O | O | CH₃ | H | H | H | O | O | 10 |
| 111 | TMP | OEt | O | O | H | H | CH₃ | H | O | O | 10 |
| 112 | TMP | OEt | O | O | CH₃ | CH₃ | H | H | O | O | 10 |
| 113 | TMP | OEt | O | O | H | H | CH₃ | CH₃ | O | O | 10 |
| 114 | TMP | OEt | O | O | Vinyl | H | H | H | O | O | 10 |
| 115 | TMP | OEt | O | O | Ph | H | H | H | O | O | 10 |
| 116 | TMP | OEt | O | O | H | H | H | H | N | O | 10 |
| 117 | TMP | OEt | O | O | CH₃ | H | H | H | N | O | 10 |
| 118 | TMP | OEt | O | O | H | H | CH₃ | H | N | O | 10 |
| 119 | TMP | OEt | O | O | H | H | H | H | O | N | 10 |
| 120 | TMP | OEt | O | O | H | H | H | H | O | N | 10 |
| 121 | TMP | TMB | O | O | H | H | H | H | O | O | 1 |
| 122 | TMP | TMB | O | O | CH₃ | H | H | H | O | O | 1 |
| 123 | TMP | TMB | O | O | H | H | CH₃ | H | O | O | 1 |
| 124 | TMP | TMB | O | O | CH₃ | CH₃ | H | H | O | O | 1 |
| 125 | TMP | TMB | O | O | H | H | CH₃ | CH₃ | O | O | 1 |
| 126 | TMP | TMB | O | O | Vinyl | H | H | H | O | O | 1 |
| 127 | TMP | TMB | O | O | Ph | H | H | H | O | O | 1 |
| 128 | TMP | TMB | O | O | H | H | H | H | N | O | 1 |
| 129 | TMP | TMB | O | O | CH₃ | H | H | H | N | O | 1 |
| 130 | TMP | TMB | O | O | H | H | CH₃ | H | N | O | 1 |
| 131 | TMP | TMB | O | O | H | H | H | H | O | N | 1 |
| 132 | TMP | TMB | O | O | H | H | H | H | O | N | 1 |
| 133 | TMP | TMB | O | O | H | H | H | H | O | O | 2 |
| 134 | TMP | TMB | O | O | CH₃ | H | H | H | O | O | 2 |
| 135 | TMP | TMB | O | O | H | H | CH₃ | H | O | O | 2 |
| 136 | TMP | TMB | O | O | CH₃ | CH₃ | H | H | O | O | 2 |
| 137 | TMP | TMB | O | O | H | H | CH₃ | CH₃ | O | O | 2 |
| 138 | TMP | TMB | O | O | Vinyl | H | H | H | O | O | 2 |
| 139 | TMP | TMB | O | O | Ph | H | H | H | O | O | 2 |
| 140 | TMP | TMB | O | O | H | H | H | H | N | O | 2 |
| 141 | TMP | TMB | O | O | CH₃ | H | H | H | N | O | 2 |
| 142 | TMP | TMB | O | O | H | H | CH₃ | H | N | O | 2 |
| 143 | TMP | TMB | O | O | H | H | H | H | O | N | 2 |
| 144 | TMP | TMB | O | O | H | H | H | H | O | N | 2 |
| 145 | TMP | TMB | O | O | H | H | H | H | O | O | 3 |
| 146 | TMP | TMB | O | O | CH₃ | H | H | H | O | O | 3 |
| 147 | TMP | TMB | O | O | H | H | CH₃ | H | O | O | 3 |
| 148 | TMP | TMB | O | O | CH₃ | CH₃ | H | H | O | O | 3 |
| 149 | TMP | TMB | O | O | H | H | CH₃ | CH₃ | O | O | 3 |
| 150 | TMP | TMB | O | O | Vinyl | H | H | H | O | O | 3 |
| 151 | TMP | TMB | O | O | Ph | H | H | H | O | O | 3 |
| 152 | TMP | TMB | O | O | H | H | H | H | N | O | 3 |
| 153 | TMP | TMB | O | O | CH₃ | H | H | H | N | O | 3 |
| 154 | TMP | TMB | O | O | H | H | CH₃ | H | N | O | 3 |
| 155 | TMP | TMB | O | O | H | H | H | H | O | N | 3 |
| 156 | TMP | TMB | O | O | H | H | H | H | O | N | 3 |
| 157 | TMP | TMB | O | O | H | H | H | H | O | O | 5 |
| 158 | TMP | TMB | O | O | CH₃ | H | H | H | O | O | 5 |
| 159 | TMP | TMB | O | O | H | H | CH₃ | H | O | O | 5 |
| 160 | TMP | TMB | O | O | CH₃ | CH₃ | H | H | O | O | 5 |
| 161 | TMP | TMB | O | O | H | H | CH₃ | CH₃ | O | O | 5 |
| 162 | TMP | TMB | O | O | Vinyl | H | H | H | O | O | 5 |
| 163 | TMP | TMB | O | O | Ph | H | H | H | O | O | 5 |
| 164 | TMP | TMB | O | O | H | H | H | H | N | O | 5 |
| 165 | TMP | TMB | O | O | CH₃ | H | H | H | N | O | 5 |
| 166 | TMP | TMB | O | O | H | H | CH₃ | H | N | O | 5 |
| 167 | TMP | TMB | O | O | H | H | H | H | O | N | 5 |
| 168 | TMP | TMB | O | O | H | H | H | H | O | N | 5 |
| 169 | TMP | TMB | O | O | H | H | H | H | O | O | 10 |
| 170 | TMP | TMB | O | O | CH₃ | H | H | H | O | O | 10 |
| 171 | TMP | TMB | O | O | H | H | CH₃ | H | O | O | 10 |
| 172 | TMP | TMB | O | O | CH₃ | CH₃ | H | H | O | O | 10 |
| 173 | TMP | TMB | O | O | H | H | CH₃ | CH₃ | O | O | 10 |
| 174 | TMP | TMB | O | O | Vinyl | H | H | H | O | O | 10 |
| 175 | TMP | TMB | O | O | Ph | H | H | H | O | O | 10 |
| 176 | TMP | TMB | O | O | H | H | H | H | N | O | 10 |
| 177 | TMP | TMB | O | O | CH₃ | H | H | H | N | O | 10 |
| 178 | TMP | TMB | O | O | H | H | CH₃ | H | N | O | 10 |
| 179 | TMP | TMB | O | O | H | H | H | H | O | N | 10 |
| 180 | TMP | TMB | O | O | H | H | H | H | O | N | 10 |

TMP: 2,4,6-trimethyl-1-phenyl
DMP: 2,6-dimethyl-1-phenyl
DMOP: 2,6-dimethoxy-1-phenyl
DCP: 2,6-dichloro-1-phenyl
TMB: 2,4,6-trimethylbenzoyl
Ph: phenyl
EtO: ethoxy

As stated above, preference is also given to the species from the table in which R² is 4-methylphenyl, 4-methoxyphenyl, 4-chlorophenyl, methoxy, n-propoxy, iso-propoxy, n-butoxy, sec-butoxy, iso-butoxy or tert-butoxy.

As stated above, preference is also given to the species from the table in which R¹ is ortho-substituted, for example 2,6-dimethyl-1-phenyl, 2,6-dimethoxy-1-phenyl, 2,6-dichloro-1-phenyl, 2-methylphenyl, 2-methoxyphenyl or 2-chlorophenyl.

The acyl- and bisacylphosphine derivatives (I) according to the invention are obtainable, for example, by a process which comprises reacting a substance of the formula (II)

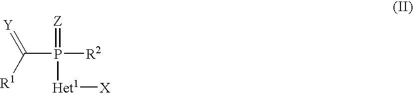

where R¹, R², Y, Z and Het¹ are as defined above, and

X is hydrogen or a cation,

with at least one alkylene oxide, aziridine or thiirane of the formula (III)

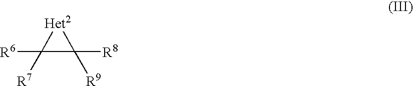

where Het², R⁶, R⁷, R⁸ and R⁹ are as defined above.

Preferred compounds of the formula (III) are ethylene oxide, propylene oxide, iso-butylene oxide, styrene oxide, vinyl oxirane, aziridine, N-methylaziridine and thiirane, if desired in the form of a mixture, particularly preferably ethylene oxide, propylene oxide, iso-butylene oxide, styrene oxide and vinyl oxirane, very particularly preferably ethylene oxide, propylene oxide and iso-butylene oxide and especially ethylene oxide.

Cations X here can be, for example, those as mentioned in EP-A 62 839, i.e. equivalents of a cation from main group 1 to 3 of the Periodic Table of the Elements having a molecular weight of less than 138 or ammonium ions derived from quaternary ammonium ions or triethylenediammonium ions.

The reaction of the compounds (II) with an alkylene oxide, aziridine or thiirane of the formula (III) is known per se to the person skilled in the art. Possible forms of this reaction are given in Houben-Weyl, Methoden der Organischen Chemie, 4th edition, 1979, Thieme Verlag, Stuttgart, Ed. Heinz Kropf, Volume 6/1a, Part 1, pages 373 to 385.

The reaction is preferably carried out as follows:

The compound (II), if desired dissolved in a suitable solvent, for example benzene, toluene, xylene, tetrahydrofuran, hexane, pentane or petroleum ether, is initially introduced at temperatures between O° C and 120° C, preferably between 10 and 100° C. and particularly preferably between 20 and 80° C., preferably under a protective gas, for example nitrogen. The alkylene oxide, if desired at a temperature of from −30° C. to 50° C., dissolved in one of the abovementioned solvents, is metered in continuously or in portions with thorough mixing at such a rate that the temperature of the reaction mixture is held at between 120 and 180° C., preferably between 120 and 150° C. The reaction can take place under a pressure of up to 60 bar, preferably up to 30 bar and particularly preferably up to 10 bar.

The amount of (III) here is set in such a way that up to (1.1×n) mol of (III), preferably up to (1.05×n) mol of (III) and particularly preferably n mol of (III), where n is as defined above, are metered in per mole of compound (II).

If desired, up to 50 mol %, based on (II), particularly preferably up to 25 mol % and very particularly preferably up to 10 mol %, of a catalyst can be added for acceleration, for example water, monoethanolamine, diethanolamine, triethanolamine, dimethylaminoethanolamine, ethylene glycol or diethylene glycol, as well as alkali metal hydroxides, alkoxides or hydrotalcite, preferably alkali metal hydroxides in water.

After all the (III) has been metered in, the mixture is generally allowed to react for a further from 10 to 500 minutes, preferably from 20 to 300 minutes, particularly preferably from 30 to 180 minutes, at temperatures between 30 and 220° C., preferably from 80 to 200° C. and particularly preferably from 100 to 180° C., it being possible for the temperature to remain constant or to be increased stepwise or continuously.

The conversion of (III) is preferably at least 90%, particularly preferably at least 95% and very particularly preferably at least 98%. Any residues of (III) can be stripped out by passing a gas, for example nitrogen, helium, argon or steam, through the reaction mixture.

The reaction can be carried out, for example, discontinuously, semi-continuously or continuously in a stirred reactor or else continuously in a tubular reactor with static mixers.

The reaction is preferably carried out entirely in the liquid phase.

The reaction product formed can be processed further in crude or worked-up form.

If further use in pure form is desired, the product can be purified, for example by crystallization and solid/liquid separation.

The yields are generally greater than 75%, usually greater than 80% and frequently greater than 90%.

The compounds of the formula (II) where Het¹=O can be obtained as described in EP-A 62 839: a phosphinic acid ester (III) prepared, for example, as mentioned at the outset can be reacted with a metal halide (MeHal), for example LiCl, LiBr, LiI, NaCl, NaBr, NaI, KCl, KBr or KI, to give the compound (II), where X corresponds to the metal used (Me). Acidification, for example using sulfuric acid, hydrochloric acid, phosphoric acid, nitric acid or sulfonic acids, or metal exchange with ion exchangers results in the compound (II) where X═H.

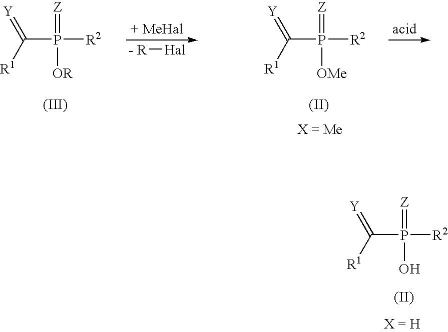

The acyl- and bisacylphosphine derivatives of the formula (I) according to the invention can be used as photoinitiators in photopolymerizable compositions, for example coating compositions, surface coatings, printing inks, recording materials, aqueous solutions, dispersions and emulsions.

They exhibit a migration tendency which is generally lower than most conventional acyl- and bisacylphosphine oxide compounds, particularly if the radiation-curable composition contains at least one polar group and/or at least one reactive center which is/are able to interact with the -Het²-H group of the compounds of the formula (I).

Reactive centers in radiation-curable compositions are those which are able to form a chemical bond with the -Het²-H group of the compounds (I).

These can be, for example, isocyanate, epoxide, anhydride, acid chloride, ester, acid, carbonate, aldehyde, α,β-unsaturated carbonyl, chloroalkyl, bromoalkyl, iodoalkyl or nitrile groups.

Preference is given to isocyanate, epoxide, ester, acid, carbonate, aldehyde and a,p-unsaturated carbonyl groups.

Particular preference is given to isocyanate, epoxide, ester and α,β-unsaturated carbonyl groups.

Very particular preference is given to isocyanate, epoxide and α,β-unsaturated carbonyl groups.

Polar groups in radiation-curable compositions which are able to interact with -Het²-H groups in the compounds of the formula (I) are those which are able to form, for example, electrostatic interactions, dipole-dipole interactions, induction (Debye) interactions or hydrogen bonds.

These are, for example, hydroxyl, mono-, di- and unsubstituted amino, carboxyl, sulfonyl, ammonium, carboxylate, sulfonate or amide groups, preferably hydroxyl, mono-, di- and unsubstituted amino, carboxyl, ammonium, carboxylate or sulfonate groups.

Particular preference is given to hydroxyl, mono-, di- and unsubstituted amino, carboxyl or ammonium groups.

Very particular preference is given to hydroxyl, mono-, di- and unsubstituted amino groups.

The polar groups or reactive centers in the radiation-curable compositions may be present in any desired component for their build-up, preferably in the binder.

Suitable binders of this type comprise, for example, at least one polymerizable compound having one or more copolymerizable, ethylenically unsaturated groups and at least one reactive center and/or at least one polar group. These can be, for example, urethane, melamine, polyesterol, polyetherol, epoxide or carbonate acrylates, methacrylates or vinyl ethers containing reactive centers and/or polar groups.

The preparation of urethane, melamine, polyesterol, polyetherol, epoxide or carbonate acrylates, methacrylates or vinyl ethers of this type is known per se to the person skilled in the art.

The number of reactive centers, polar groups and ethylenically unsaturated groups can be adjusted through suitable mixing of the individual components.

The number average molecular weight Mn of the polymerizable compounds which can be employed is not restricted. It can be., for example, below 20,000, preferably below 15,000, particularly preferably below 10,000 and in particular below 6000.

The polydispersity M_{w}/Mₙ, the quotient of the number average molecular weight and the weight average molecular weight of the polymerizable compounds, represents a measure of the molecular weight distribution of the polymerizable compounds and in the ideal case has the value 1, but in practice values below 4.0, in particular below 3.5, are also satisfactory.

The data on the polydispersity and the number average and weight average molecular weights Mₙ and M_{w} are based here on gel permeation chromatography measurements, with polystyrene as standard and tetrahydrofuran as eluent. The method is described in Analytiker Taschenbuch, Vol. 4, pages 433 to 442, Berlin, 1984.

The present invention furthermore relates to acyl- and. bisacylphosphine derivatives (IVa-g) which are obtainable by reaction of the compounds (I) or (II) with compounds which contain at least one reactive center in the abovementioned sense.

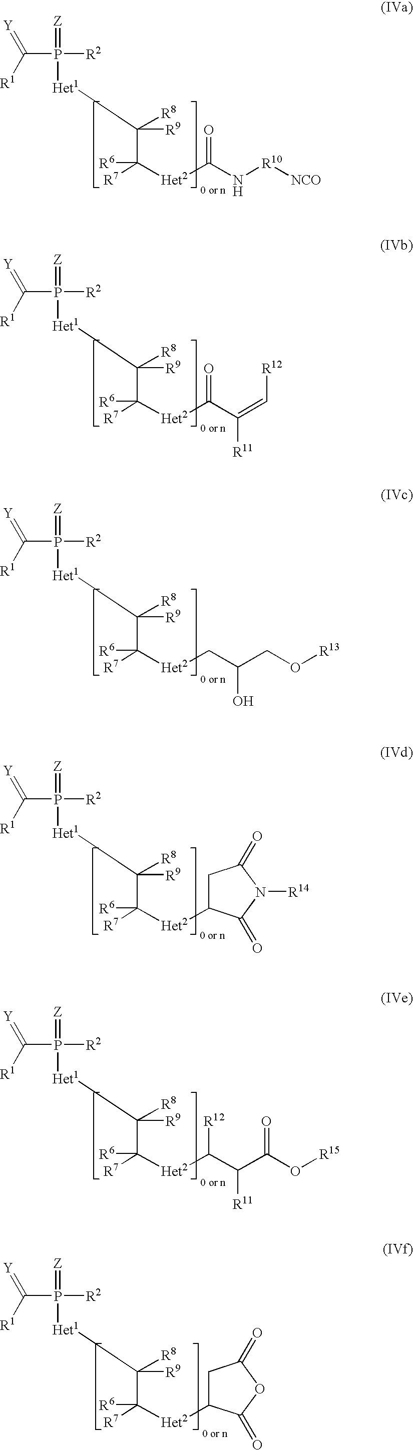

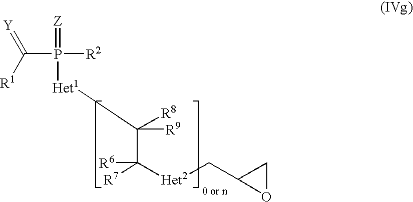

This covers, for example, acyl- and bisacylphosphine derivatives which are obtainable by reaction of compounds (I) or (II) with

isocyanate group-containing compounds, for example to give compounds (IVa),

α,β-unsaturated carboxylic acids or esters in the sense of an esterification or transesterification, for example to give compounds (IVb),

epoxide group-containing compounds, for example to give compounds (IVc) or (IVg), or

α,β-unsaturated carbonyl compounds in the sense of a Michael reaction, for example with

maleimides or maleimide-containing compounds, for example to give compounds (IVd),

(meth)acrylates, crotonates, fumarates or maleates, for example to give compounds (IVe), or

maleic anhydride, for example to give compounds (IVf).

The acyl- and bisacylphosphine derivatives obtainable in this way may themselves carry reactive centers, polar groups or copolymerizable groups, meaning that these compounds can be used as photoinitiators with a low migration tendency.

Suitable isocyanates which can be reacted with acyl- and bisacylphosphine derivatives (I) or (II) are, for example, organic aliphatic, aromatic or cycloaliphatic di- or polyisocyanates.

Suitable as such are, for example, aliphatic, aromatic and cycloaliphatic di- and polyisocyanates having an NCO functionality of at least 1.8, preferably from 1.8 to 5 and particularly preferably from 2 to 4, and their isocyanurates, biurets, allophanates and uretdiones.

The diisocyanates are preferably isocyanates having from 4 to 20 carbon atoms. Examples of conventional diisocyanates are

aliphatic diisocyanates, such as tetramethylene diisocyanate,

hexamethylene diisocyanate (1,6-diisocyanatohexane),

octamethylene diisocyanate, decamethylene diisocyanate,

dodecamethylene diisocyanate, tetradecamethylene diisocyanate,

derivatives of lysine diisocyanate, tetramethylxylylene

diisocyanate, trimethylhexane diisocyanate or tetramethylhexane

diisocyanate, cycloaliphatic diisocyanates, such as 1,4-, 1,3- or

1,2-diisocyanatocyclohexane, 4,4′- or

2,4′-di(isocyanatocyclohexyl)methane,

1-isocyanato-3,3,5-trimethyl-5-(isocyanatomethyl)cyclohexane (isophorone diisocyanate), 1,3- or

1,4-bis(isocyanatomethyl)cyclohexane or 2,4- or

2,6-diisocyanato-1-methylcyclohexane, as well as aromatic

diisocyanates, such as 2,4- or 2,6-tolylene diisocyanate and isomer mixtures thereof, m- or p-xylylene diisocyanate, 2,4′- or

4,4′-diisocyanatodiphenylmethane and isomer mixtures thereof,

1,3- or 1,4-phenylene diisocyanate, 1-chloro-2,4-phenylene

diisocyanate, 1,5-naphthylene diisocyanate, diphenylene

4,4′-diisocyanate, 4,4′-diisocyanato-3,3′-dimethylbiphenyl,

3-methylbiphenylmethane, 4,4′-diisocyanate, tetramethylxylylene

diisocyanate, 1,4-diisocyanatobenzene or diphenyl ether

4,4′-diisocyanate.

It is also possible for mixtures of the said diisocyanates to be present.

Preference is given to hexamethylene diisocyanate, 1,3-bis(isocyanatomethyl)cyclohexane, isophorone diisocyanate and di(isocyanatocyclohexyl)methane.

Suitable polyisocyanates are isocyanurate group-containing polyisocyanates, uretdione diisocyanates, biuret group-containing polyisocyanates, urethane or allophanate group-containing polyisocyanates, oxadiazinetrione group-containing polyisocyanates, uretonimine-modified polyisocyanates of straight-chain or branched C₄-C₂₀-alkylene diisocyanates, cycloaliphatic diisocyanates having a total of from 6 to 20 carbon atoms or aromatic diisocyanates having a total of from 8 to 20 carbon atoms, or mixtures thereof.

The di- and polyisocyanates which can be employed preferably have a content of isocyanate groups (calculated as NCO, molecular weight=42) of from 10 to 60% by weight, based on the di- and polyisocyanate (mixture), preferably from 15 to 60% by weight and particularly preferably from 20 to 55% by weight.

Preference is given to aliphatic and cycloaliphatic di- and polyisocyanates, for example the abovementioned aliphatic and cycloaliphatic diisocyanates, or mixtures thereof.

Preference is furthermore given to the following:

1) isocyanurate group-containing polyisocyanates of aromatic, aliphatic and/or cycloaliphatic diisocyanates. Particular preference is given here to the corresponding aliphatic and/or cycloaliphatic isocyanatoisocyanurates and in particular to those based on hexamethylene diisocyanate and isophorone diisocyanate. The present isocyanurates are, in particular, trisisocyanatoalkyl or trisisocyanatocycloalkyl isocyanurates, which are cyclic trimers of the diisocyanates, or mixtures with their higher homologs having more than one isocyanurate ring. The isocyanatoisocyanurates generally have an NCO content of from 10 to 30% by weight, in particular from 15 to 25% by weight, and a mean NCO functionality of from 3 to 4.5.

2) Uretdione diisocyanates containing aromatically, aliphatically and/or cycloaliphatically bonded isocyanate groups, preferably aliphatically and/or cycloaliphatically bonded isocyanate groups and in particular those which are derived from hexamethylene diisocyanate or isophorone diisocyanate. Uretdione diisocyanates are cyclic dimerization products of diisocyanates. The uretdione diisocyanates can be employed in the preparations according to the invention as the only component or as a mixture with other polyisocyanates, in particular those mentioned under 1).

3) Biuret group-containing polyisocyanates containing aromatically, cycloaliphatically or aliphatically bonded, preferably cycloaliphatically or aliphatically bonded isocyanate groups, in particular tris(6-isocyanatohexyl)biuret or mixtures thereof with its higher homologs. These biuret group-containing polyisocyanates generally have an NCO content of from 18 to 22%-by weight and a mean NCO functionality of from 3 to 4.5.

4) Urethane and/or allophanate group-containing polyisocyanates containing aromatically, aliphatically or cycloaliphatically bonded, preferably aliphatically or cycloaliphatically bonded isocyanate groups, as can be obtained, for example, by reaction of excess amounts of hexamethylene diisocyanate or of isophorone diisocyanate with polyhydric alcohols, for example trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These urethane and/or allophanate group-containing polyisocyanates generally have an NCO content of from 12 to 20% by weight and a mean NCO functionality of from 2.5 to 3.

) Oxadiazinetrione group-containing polyisocyanates, preferably derived from hexamethylene diisocyanate or isophorone diisocyanate. Oxadiazinetrione group-containing polyisocyanates of this type can be prepared from diisocyanate and carbon dioxide.

6) Uretonimine-modified polyisocyanates.

The polyisocyanates 1) to 6) can be employed in the form of a mixture, if desired also in the form of a mixture with diisocyanates.

α,β-Unsaturated carboxylic acids or esters for esterification or transesterification can be, for example, acrylic acid, ethacrylic acid, crotonic acid, maleic acid, fumaric acid or esters thereof with methanol, ethanol, iso-propanol, n-propanol, n-butanol, iso-butanol, sec-butanol, tert-butanol, n-octanol or 2-ethylhexanol.

Preference is given to methyl methacrylate, and methyl, ethyl, 2-ethylhexyl and n-butyl acrylate.

Suitable epoxide group-containing compounds are, for example, those which carry on average at least one, preferably at least two, particularly preferably two epoxide groups. These can be, for example, epichlorohydrin or epoxides obtained from the reaction of bisphenol A, F or S or tetrabromobisphenol A with epichlorohydrin (or glycidyl ethers thereof), tris[4-(2,3-epoxypropoxy)phenyl]methane isomers, cycloaliphatic diepoxides, such as the diglycidyl ether of hydrogenated bisphenol A (2,2-bis[4-(2,3-epoxypropoxy)cyclohexyl]propane), aliphatic epoxides, for example the diglycidyl ethers of 1,4-butanediol, 1,6-hexanediol, 1,3-propanediol, trimethylolpropane, neopentyl glycol or pentaerythritol, epoxidized fatty acids, aromatic glycidylamines, for example the triglycidyl adduct of p-aminophenol, 1-(2,3-epoxypropoxy)-4-[N,N-bis(2,3-epoxypropyl)amino]benzene or the tetraglycidylamines of methylenedianiline or bis-4-[N,N-bis(2,3-epoxypropyl)amino]phenylmethane, and products of the reaction of epichlorohydrin with o-cresol- or phenol-novolaks or hydrocarbon-epoxy novolaks, for example the product of the alkylation of phenol and dicyclopentadiene.

α,β-Unsaturated carbonyl compounds with which a reaction can be carried out in the sense of a Michael reaction are, for example, bismaleimides containing C₂- to C₁₆-alkylene, C₅- to C₂₀-cycloalkylene, C₆- to C₁₈-arylene and C₇- to C₂₄-alkylarylene groups, each of which may contain oxygen or sulfur atoms or imino groups, preferably 1,2-ethylene, 1,3-propylene, 1,6-hexylene, 1,12-dodecylene, 2,2,4-trimethylhexylene, oxydipropylene, aminodipropylene, ethylenedioxypropylene,

ethylenedioxydipropylene, 1,4-cyclohexylene,

isopropylidene-1,4-dicyclohexylene, oxy-1,4-cyclohexylene, 1,2-,

1,3- or 1,4-phenylene, 4,4′-biphenylene, 4,4′-bisphenylmethylene,

1,3-, 1,4- or 1,5-naphthylene, 3,3′-dimethyl-4,4′-diphenylene,

3,3′-dichloro-4,4′-diphenylene, 2,4- or 2,6-pyridyl,

1,4-anthraquinonediyl, m- or p-tolylene,

4,6-dimethyl-1,3-phenylene, 4,6-dichloro-1,3-phenylene,

5-chloro-1,3-phenylene, 5-hydroxy-1,3-phenylene,

30 5-methoxy-1,3-phenylene, 2,3-dimethyl-1,4-phenylene, m- or

p-xylylene, methylenedi-p-phenylene,

isopropylidenedi-p-phenylene, thiodi-p-phenylene,

dithiodi-p-phenylene, sulfodi-p-phenylene,

carbonyldi-p-phenylene, or 4,4′-bisphenyl ether, maleic anhydride, methyl, ethyl, n-butyl, 2-ethylhexyl or n-octyl (meth)acrylate, dimethylaminoethyl acrylate, trimethylolpropane mono-, di- and triacrylate, 1,6-hexanediol mono- and diacrylate,

1,2-ethylene glycol mono- and diacrylate, 1,3-propanediol mono- and diacrylate, 1,4-butanediol mono- and diacrylate, neopentyl glycol mono- and diacrylate or pentaerythritol mono-, di-, tri- and tetraacrylate.

Examples of radicals are thus

R¹⁰ 1,2-ethylene, 1,4-butylene, 1,6-hexylene, 1,2-, 1,3- or

1,4-cyclohexylene, 1,3,3-trimethyl-1,5-cyclohexylene,

1-methyl-2,4-phenylene, 1-methyl-2,6-phenylene,

4,4′-diphenylmethylene, 2,4′-diphenylmethylene or

2′,4-diphenylmethylene,

R¹¹ hydrogen or methyl,

R¹² hydrogen, E- or Z-methyl, -ethyl, -methoxycarbonyl, -ethoxycarbonyl, -n-butoxycarbonyl or -2-ethylhexyloxycarbonyl,

R¹³ hydrogen, methyl, ethyl, n-butyl, 2-ethylhexyl, n-octyl,

1-isopropylidene-4′-hydroxyphenylphen-4-yl,

1-methylene-4′-hydroxyphenylphen-4-yl,

1-isopropylidene-4′-[(2″, 3″-epoxyprop-1″-yloxy)phenyl]phen-4-yl,

1-methylene-4′-[(2″,3″-epoxyprop-1″-yloxy)phenyl]-phen-4-yl,

1-isopropylidene-4′-hydroxycyclohexylcyclohex-4-yl

or 1-methylene-4′-hydroxycyclohexylcyclohex-4-yl,

R¹⁴ hydrogen, methyl, ethyl, iso-propyl, n-propyl, n-butyl,

iso-butyl, sec-butyl, tert-butyl, 2-ethylhexyl, n-octyl,

2-maleimidoethyl, 3-maleimidopropyl, 6-maleimidohexyl,

12-maleimidododecyl, 6-maleimido-2,2,4-trimethylhexylene,

4-maleimidocyclohexylene, 4-maleimidophenyl,

4-(4′-maleimidophenyl)phenyl, 4-(4′-maleimidophenoxy)phenyl,

1-methylene(4′-maleimidophenyl)phen-4-yl or

1-isopropylidene(4′-maleimidophenyl)phen-4-yl, and

R¹⁵ hydrogen, methyl, ethyl, iso-propyl, n-propyl, n-butyl,

iso-butyl, sec-butyl, tert-butyl, 2-ethylhexyl, n-octyl,

2-dimethylaminoethyl, 2-(meth)acryloxyethyl,

3-(meth)acryloxypropyl, 2,2-dimethyl-3-(meth)acryloxypropyl,

4-(meth)acryloxybutyl, 6-(meth)acryloxyhexyl,

2,2-di[(meth)acryloxymethyl]but-1-yl or

2,2,2-tri[(meth)acryloxymethyl]eth-1-yl.

Of the acyl- and bisacylphosphine derivatives described by the formula (IVa), particular preference is given to the following species IVa-1 to IVa-60, in which the radicals in the formula (IVa) have the following meanings:

| IVa- | R¹ | R² | Y | Z | R⁶ | R⁷ | R⁸ | R⁹ | Het¹ | Het² | n | R¹⁰ |
|---|---|---|---|---|---|---|---|---|---|---|---|---|
| 1 | TMP | Ph | O | O | H | H | H | H | O | O | 0 | 1,6-Hexylene |
| 2 | TMP | Ph | O | O | H | H | H | H | O | O | 1 | 1,6-Hexylene |
| 3 | TMP | Ph | O | O | H | H | H | H | O | O | 2 | 1,6-Hexylene |
| 4 | TMP | Ph | O | O | H | H | H | H | O | O | 3 | 1,6-Hexylene |
| 5 | TMP | Ph | O | O | H | H | H | H | O | O | 4 | 1,6-Hexylene |
| 6 | TMP | Ph | O | O | H | H | H | H | O | O | 5 | 1,6-Hexylene |
| 7 | TMP | Ph | O | O | H | H | H | H | O | O | 0 | 1-Methyl-2,4- |
| | | | | | | | | | | | | phenylene |
| 8 | TMP | Ph | O | O | H | H | H | H | O | O | 1 | 1-Methyl-2,4- |
| | | | | | | | | | | | | phenylene |
| 9 | TMP | Ph | O | O | H | H | H | H | O | O | 2 | 1-Methyl-2,4- |
| | | | | | | | | | | | | phenylene |
| 10 | TMP | Ph | O | O | H | H | H | H | O | O | 3 | 1-Methyl-2,4- |
| | | | | | | | | | | | | phenylene |
| 11 | TMP | Ph | O | O | H | H | H | H | O | O | 4 | 1-Methyl-2,4- |
| | | | | | | | | | | | | phenylene |
| 12 | TMP | Ph | O | O | H | H | H | H | O | O | 5 | 1-Methyl-2,4- |
| | | | | | | | | | | | | phenylene |
| 13 | TMP | Ph | O | O | H | H | H | H | O | O | 0 | 1-Methyl-2,6- |
| | | | | | | | | | | | | phenylene |
| 14 | TMP | Ph | O | O | H | H | H | H | O | O | 1 | 1-Methyl-2,6- |
| | | | | | | | | | | | | phenylene |
| 15 | TMP | Ph | O | O | H | H | H | H | O | O | 2 | 1-Methyl-2,6- |
| | | | | | | | | | | | | phenylene |
| 16 | TMP | Ph | O | O | H | H | H | H | O | O | 3 | 1-Methyl-2,6- |
| | | | | | | | | | | | | phenylene |
| 17 | TMP | Ph | O | O | H | H | H | H | O | O | 4 | 1-Methyl-2,6- |
| | | | | | | | | | | | | phenylene |
| 18 | TMP | Ph | O | O | H | H | H | H | O | O | 5 | 1-Methyl-2,6- |
| | | | | | | | | | | | | phenylene |
| 19 | TMP | Ph | O | O | H | H | H | H | O | O | 0 | 3,5,5- |
| | | | | | | | | | | | | Trimethyl-1,3- |
| | | | | | | | | | | | | cyclohexylene |
| 20 | TMP | Ph | O | O | H | H | H | H | O | O | 1 | 3,5,5- |
| | | | | | | | | | | | | Trimethyl-1,3- |
| | | | | | | | | | | | | cyclohexylene |
| 21 | TMP | Ph | O | O | H | H | H | H | O | O | 2 | 3,5,5- |
| | | | | | | | | | | | | Trimethyl-1,3- |
| | | | | | | | | | | | | cyclohexylene |
| 22 | TMP | Ph | O | O | H | H | H | H | O | O | 3 | 3,5,5- |
| | | | | | | | | | | | | Trimethyl-1,3- |
| | | | | | | | | | | | | cyclohexylene |
| 23 | TMP | Ph | O | O | H | H | H | H | O | O | 4 | 3,5,5- |
| | | | | | | | | | | | | Trimethyl-1,3- |
| | | | | | | | | | | | | cyclohexylene |
| 24 | TMP | Ph | O | O | H | H | H | H | O | O | 5 | 3,5,5- |
| | | | | | | | | | | | | Trimethyl-1,3- |
| | | | | | | | | | | | | cyclohexylene |
| 25 | TMP | Ph | O | O | H | H | H | H | O | O | 0 | 4,4′-Diphenyl- |
| | | | | | | | | | | | | methylene |
| 26 | TMP | Ph | O | O | H | H | H | H | O | O | 1 | 4,4′-Diphenyl- |
| | | | | | | | | | | | | methylene |
| 27 | TMP | Ph | O | O | H | H | H | H | O | O | 2 | 4,4′-Diphenyl- |
| | | | | | | | | | | | | methylene |
| 28 | TMP | Ph | O | O | H | H | H | H | O | O | 3 | 4,4′-Diphenyl- |
| | | | | | | | | | | | | methylene |
| 29 | TMP | Ph | O | O | H | H | H | H | O | O | 4 | 4,4′-Diphenyl- |
| | | | | | | | | | | | | methylene |
| 30 | TMP | Ph | O | O | H | H | H | H | O | O | 5 | 4,4′-Diphenyl- |
| | | | | | | | | | | | | methylene |
| 31 | TMP | EtO | O | O | H | H | H | H | O | O | 0 | 1,6-Hexylene |
| 32 | TMP | EtO | O | O | H | H | H | H | O | O | 1 | 1,6-Hexylene |
| 33 | TMP | EtO | O | O | H | H | H | H | O | O | 2 | 1,6-Hexylene |
| 34 | TMP | EtO | O | O | H | H | H | H | O | O | 3 | 1,6-Hexylene |
| 35 | TMP | EtO | O | O | H | H | H | H | O | O | 4 | 1,6-Hexylene |
| 36 | TMP | EtO | O | O | H | H | H | H | O | O | 5 | 1,6-Hexylene |
| 37 | TMP | EtO | O | O | H | H | H | H | O | O | 0 | 1-Methyl-2,4- |
| | | | | | | | | | | | | phenylene |
| 38 | TMP | EtO | O | O | H | H | H | H | O | O | 1 | 1-Methyl-2,4- |
| | | | | | | | | | | | | phenylene |
| 39 | TMP | EtO | O | O | H | H | H | H | O | O | 2 | 1-Methyl-2,4- |
| | | | | | | | | | | | | phenylene |
| 40 | TMP | EtO | O | O | H | H | H | H | O | O | 3 | 1-Methyl-2,4- |
| | | | | | | | | | | | | phenylene |
| 41 | TMP | EtO | O | O | H | H | H | H | O | O | 4 | 1-Methyl-2,4- |
| | | | | | | | | | | | | phenylene |
| 42 | TMP | EtO | O | O | H | H | H | H | O | O | 5 | 1-Methyl-2,4- |
| | | | | | | | | | | | | phenylene |
| 43 | TMP | EtO | O | O | H | H | H | H | O | O | 0 | 1-Methyl-2,6- |
| | | | | | | | | | | | | phenylene |
| 44 | TMP | EtO | O | O | H | H | H | H | O | O | 1 | 1-Methyl-2,6- |
| | | | | | | | | | | | | phenylene |
| 45 | TMP | EtO | O | O | H | H | H | H | O | O | 2 | 1-Methyl-2,6- |
| | | | | | | | | | | | | phenylene |
| 46 | TMP | EtO | O | O | H | H | H | H | O | O | 3 | 1-Methyl-2,6- |
| | | | | | | | | | | | | phenylene |
| 47 | TMP | EtO | O | O | H | H | H | H | O | O | 4 | 1-Methyl-2,6- |
| | | | | | | | | | | | | phenylene |
| 48 | TMP | EtO | O | O | H | H | H | H | O | O | 5 | 1-Methyl-2,6- |
| | | | | | | | | | | | | phenylene |
| 49 | TMP | EtO | O | O | H | H | H | H | O | O | 0 | 3,5,5- |
| | | | | | | | | | | | | Trimethyl-1,3- |
| | | | | | | | | | | | | cyclohexylene |
| 50 | TMP | EtO | O | O | H | H | H | H | O | O | 1 | 3,5,5- |
| | | | | | | | | | | | | Trimethyl-1,3- |
| | | | | | | | | | | | | cyclohexylene |
| 51 | TMP | EtO | O | O | H | H | H | H | O | O | 2 | 3,5,5- |
| | | | | | | | | | | | | Trimethyl-1,3- |
| | | | | | | | | | | | | cyclohexylene |
| 52 | TMP | EtO | O | O | H | H | H | H | O | O | 3 | 3,5,5- |
| | | | | | | | | | | | | Trimethyl-1,3- |
| | | | | | | | | | | | | cyclohexylene |
| 53 | TMP | EtO | O | O | H | H | H | H | O | O | 4 | 3,5,5- |
| | | | | | | | | | | | | Trimethyl-1,3- |
| | | | | | | | | | | | | cyclohexylene |
| 54 | TMP | EtO | O | O | H | H | H | H | O | O | 5 | 3,5,5- |
| | | | | | | | | | | | | Trimethyl-1,3- |
| | | | | | | | | | | | | cyclohexylene |
| 55 | TMP | EtO | O | O | H | H | H | H | O | O | 0 | 4,4′-Diphenyl- |
| | | | | | | | | | | | | methylene |
| 56 | TMP | EtO | O | O | H | H | H | H | O | O | 1 | 4,4′-Diphenyl- |
| | | | | | | | | | | | | methylene |
| 57 | TMP | EtO | O | O | H | H | H | H | O | O | 2 | 4,4′-Diphenyl- |
| | | | | | | | | | | | | methylene |
| 58 | TMP | EtO | O | O | H | H | H | H | O | O | 3 | 4,4′-Diphenyl- |
| | | | | | | | | | | | | methylene |
| 59 | TMP | EtO | O | O | H | H | H | H | O | O | 4 | 4,4′-Diphenyl- |
| | | | | | | | | | | | | methylene |
| 60 | TMP | EtO | O | O | H | H | H | H | O | O | 5 | 4,4′-Diphenyl- |
| | | | | | | | | | | | | methylene |

TMP: 2,4,6-trimethyl-1-phenyl
DMP: 2,6-dimethyl-1-phenyl
DMOP: 2,6-dimethoxy-1-phenyl
DCP: 2,6-dichloro-1-phenyl
TMB: 2,4,6-trimethylbenzoyl
Ph: phenyl
EtO: ethoxy

As stated above, preference is also given to the species from the table in which R² is 4-methylphenyl, 4-methoxyphenyl, 4-chlorophenyl, methoxy, n-propoxy, iso-propoxy, n-butoxy, sec-butoxy, iso-butoxy or tert-butoxy.

As stated above, preference is also given to the species from the table in which R¹ is ortho-substituted, for example

2,6-dimethyl-1-phenyl, 2,6-dimethoxy-1-phenyl,

2,6-dichloro-1-phenyl, 2-methylphenyl, 2-methoxyphenyl or

2-chlorophenyl.

Of the acyl- and bisacylphosphine derivatives described by the formula (IVb), particular preference is given to the following species IVb-1 to IVb-24, in which the radicals in the formula (IVb) have the following meanings:

| IVb- | R¹ | R² | Y | Z | R⁶ | R⁷ | R⁸ | R⁹ | Het¹ | Het² | n | R¹¹ | R¹² |
|---|---|---|---|---|---|---|---|---|---|---|---|---|---|
| 1 | TMP | Ph | O | O | H | H | H | H | O | O | 0 | H | H |
| 2 | TMP | Ph | O | O | H | H | H | H | O | O | 1 | H | H |
| 3 | TMP | Ph | O | O | H | H | H | H | O | O | 2 | H | H |
| 4 | TMP | Ph | O | O | H | H | H | H | O | O | 3 | H | H |
| 5 | TMP | Ph | O | O | H | H | H | H | O | O | 4 | H | H |
| 6 | TMP | Ph | O | O | H | H | H | H | O | O | 5 | H | H |
| 7 | TMP | Ph | O | O | H | H | H | H | O | O | 0 | CH₃ | H |
| 8 | TMP | Ph | O | O | H | H | H | H | O | O | 1 | CH₃ | H |
| 9 | TMP | Ph | O | O | H | H | H | H | O | O | 2 | CH₃ | H |
| 10 | TMP | Ph | O | O | H | H | H | H | O | O | 3 | CH₃ | H |
| 11 | TMP | Ph | O | O | H | H | H | H | O | O | 4 | CH₃ | H |
| 12 | TMP | Ph | O | O | H | H | H | H | O | O | 5 | CH₃ | H |
| 13 | TMP | EtO | O | O | H | H | H | H | O | O | 0 | H | H |
| 14 | TMP | EtO | O | O | H | H | H | H | O | O | 1 | H | H |
| 15 | TMP | EtO | O | O | H | H | H | H | O | O | 2 | H | H |
| 16 | TMP | EtO | O | O | H | H | H | H | O | O | 3 | H | H |
| 17 | TMP | EtO | O | O | H | H | H | H | O | O | 4 | H | H |
| 18 | TMP | EtO | O | O | H | H | H | H | O | O | 5 | H | H |
| 19 | TMP | EtO | O | O | H | H | H | H | O | O | 0 | CH₃ | H |
| 20 | TMP | EtO | O | O | H | H | H | H | O | O | 1 | CH₃ | H |
| 21 | TMP | EtO | O | O | H | H | H | H | O | O | 2 | CH₃ | H |
| 22 | TMP | EtO | O | O | H | H | H | H | O | O | 3 | CH₃ | H |
| 23 | TMP | EtO | O | O | H | H | H | H | O | O | 4 | CH₃ | H |
| 24 | TMP | EtO | O | O | H | H | H | H | O | O | 5 | CH₃ | H |

As stated above, preference is also given to the species from the table in which R² is 4-methylphenyl, 4-methoxyphenyl, 4-chlorophenyl., methoxy, n-propoxy, iso-propoxy, n-butoxy, sec-butoxy, iso-butoxy or tert-butoxy.

As stated above, preference is also given to the species from the table in which R¹ is ortho-substituted, for example

2,6-dimethyl-1-phenyl, 2,6-dimethoxy-1-phenyl,

2,6-dichloro-1-phenyl, 2-methylphenyl, 2-methoxyphenyl or

2-chlorophenyl.

Of the acyl- and bisacylphosphine derivatives described by the formula.(IVc), particular preference is given to the following species IVc-1 to IVc-24, in which the radicals in the formula (IVc) have the following meanings:

| IVc- | R¹ | R² | Y | Z | R⁶ | R⁷ | R⁸ | R⁹ | Het¹ | Het² | n | R¹³ |
|---|---|---|---|---|---|---|---|---|---|---|---|---|
| 1 | TMP | Ph | O | O | H | H | H | H | O | O | 0 | H |
| 2 | TMP | Ph | O | O | H | H | H | H | O | O | 1 | H |
| 3 | TMP | Ph | O | O | H | H | H | H | O | O | 2 | H |
| 4 | TMP | Ph | O | O | H | H | H | H | O | O | 3 | H |
| 5 | TMP | Ph | O | O | H | H | H | H | O | O | 4 | H |
| 6 | TMP | Ph | O | O | H | H | H | H | O | O | 5 | H |
| 7 | TMP | Ph | O | O | H | H | H | H | O | O | 0 | 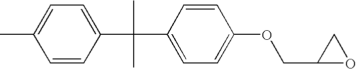 |
| 8 | TMP | Ph | O | O | H | H | H | H | O | O | 1 | 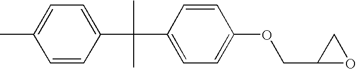 |
| 9 | TMP | Ph | O | O | H | H | H | H | O | O | 2 | 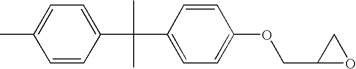 |
| 10 | TMP | Ph | O | O | H | H | H | H | O | O | 3 | 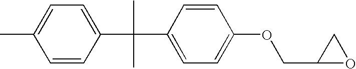 |
| 11 | TMP | Ph | O | O | H | H | H | H | O | O | 4 | 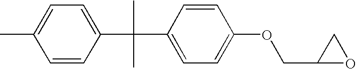 |
| 12 | TMP | Ph | O | O | H | H | H | H | O | O | 5 | 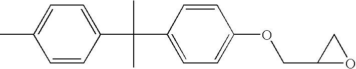 |
| 13 | TMP | EtO | O | O | H | H | H | H | O | O | 0 | H |
| 14 | TMP | EtO | O | O | H | H | H | H | O | O | 1 | H |
| 15 | TMP | EtO | O | O | H | H | H | H | O | O | 2 | H |
| 16 | TMP | EtO | O | O | H | H | H | H | O | O | 3 | H |
| 17 | TMP | EtO | O | O | H | H | H | H | O | O | 4 | H |
| 18 | TMP | EtO | O | O | H | H | H | H | O | O | 5 | H |
| 19 | TMP | EtO | O | O | H | H | H | H | O | O | 0 | 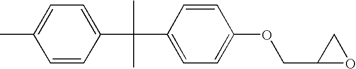 |
| 20 | TMP | EtO | O | O | H | H | H | H | O | O | 1 | 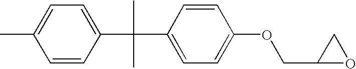 |
| 21 | TMP | EtO | O | O | H | H | H | H | O | O | 2 | 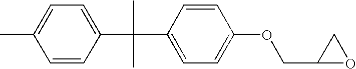 |
| 22 | TMP | EtO | O | O | H | H | H | H | O | O | 3 | 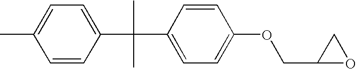 |
| 23 | TMP | EtO | O | O | H | H | H | H | O | O | 4 | 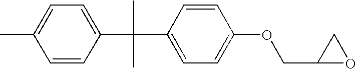 |
| 24 | TMP | EtO | O | O | H | H | H | H | O | O | 5 | 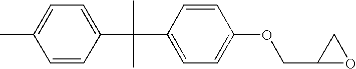 |

As stated above, preference is also given to the species from the table in which R² is 4-methylphenyl, 4-methoxyphenyl, 4-chlorophenyl, methoxy, n-propoxy, iso-propoxy, n-butoxy, sec-butoxy, iso-butoxy or tert-butoxy.

As stated above, preference is also given to the species from the table in which R¹ is ortho-substituted, for example

2,6-dimethyl1--phenyl, 2, 6-dimethoxy-1-phenyl,

2,6-dichloto-1-phenyl, 2-methylphenyl, 2-methoxyphenyl or

2-chlorophenyl.

Of the acyl- and bisacylphosphine derivatives described by the formula (IVd), particular preference is given to the following species IVd-l to IVd-36, in which the radicals in the formula (IVd) have the following meanings:

| IVd- | R¹ | R² | Y | Z | R⁶ | R⁷ | R⁸ | R⁹ | Het¹ | Het² | n | R¹⁴ |
|---|---|---|---|---|---|---|---|---|---|---|---|---|
| 1 | TMP | Ph | O | O | H | H | H | H | O | O | 0 | H |
| 2 | TMP | Ph | O | O | H | H | H | H | O | O | 1 | H |
| 3 | TMP | Ph | O | O | H | H | H | H | O | O | 2 | H |
| 4 | TMP | Ph | O | O | H | H | H | H | O | O | 3 | H |
| 5 | TMP | Ph | O | O | H | H | H | H | O | O | 4 | H |
| 6 | TMP | Ph | O | O | H | H | H | H | O | O | 5 | H |
| 7 | TMP | Ph | O | O | H | H | H | H | O | O | 0 | 6-Maleimido-1- |
| | | | | | | | | | | | | hexyl |
| 8 | TMP | Ph | O | O | H | H | H | H | O | O | 1 | 6-Maleimido-1- |
| | | | | | | | | | | | | hexyl |
| 9 | TMP | Ph | O | O | H | H | H | H | O | O | 2 | 6-Maleimido-1- |
| | | | | | | | | | | | | hexyl |
| 10 | TMP | Ph | O | O | H | H | H | H | O | O | 3 | 6-Maleimido-1- |
| | | | | | | | | | | | | hexyl |
| 11 | TMP | Ph | O | O | H | H | H | H | O | O | 4 | 6-Maleimido-1- |
| | | | | | | | | | | | | hexyl |
| 12 | TMP | Ph | O | O | H | H | H | H | O | O | 5 | 6-Maleimido-1- |
| | | | | | | | | | | | | hexyl |
| 13 | TMP | Ph | O | O | H | H | H | H | O | O | 0 | 4-Maleimido-1- |
| | | | | | | | | | | | | phenyl |
| 14 | TMP | Ph | O | O | H | H | H | H | O | O | 1 | 4-Maleimido-1- |
| | | | | | | | | | | | | phenyl |
| 15 | TMP | Ph | O | O | H | H | H | H | O | O | 2 | 4-Maleimido-1- |
| | | | | | | | | | | | | phenyl |
| 16 | TMP | Ph | O | O | H | H | H | H | O | O | 3 | 4-Maleimido-1- |
| | | | | | | | | | | | | phenyl |
| 17 | TMP | Ph | O | O | H | H | H | H | O | O | 4 | 4-Maleimido-1- |
| | | | | | | | | | | | | phenyl |
| 18 | TMP | Ph | O | O | H | H | H | H | O | O | 5 | 4-Maleimido-1- |
| | | | | | | | | | | | | phenyl |
| 19 | TMP | EtO | O | O | H | H | H | H | O | O | 0 | H |
| 20 | TMP | EtO | O | O | H | H | H | H | O | O | 1 | H |
| 21 | TMP | EtO | O | O | H | H | H | H | O | O | 2 | H |
| 22 | TMP | EtO | O | O | H | H | H | H | O | O | 3 | H |
| 23 | TMP | EtO | O | O | H | H | H | H | O | O | 4 | H |
| 24 | TMP | EtO | O | O | H | H | H | H | O | O | 5 | H |
| 25 | TMP | EtO | O | O | H | H | H | H | O | O | 0 | 6-Maleimido-1- |
| | | | | | | | | | | | | hexyl |
| 26 | TMP | EtO | O | O | H | H | H | H | O | O | 1 | 6-Maleimido-1- |
| | | | | | | | | | | | | hexyl |
| 27 | TMP | EtO | O | O | H | H | H | H | O | O | 2 | 6-Maleimido-1- |
| | | | | | | | | | | | | hexyl |
| 28 | TMP | EtO | O | O | H | H | H | H | O | O | 3 | 6-Maleimido-1- |
| | | | | | | | | | | | | hexyl |
| 29 | TMP | EtO | O | O | H | H | H | H | O | O | 4 | 6-Maleimido-1- |
| | | | | | | | | | | | | hexyl |
| 30 | TMP | EtO | O | O | H | H | H | H | O | O | 5 | 6-Maleimido-1- |
| | | | | | | | | | | | | hexyl |
| 31 | TMP | EtO | O | O | H | H | H | H | O | O | 0 | 4-Maleimido-1- |
| | | | | | | | | | | | | phenyl |
| 32 | TMP | EtO | O | O | H | H | H | H | O | O | 1 | 4-Maleimido-1- |
| | | | | | | | | | | | | phenyl |
| 33 | TMP | EtO | O | O | H | H | H | H | O | O | 2 | 4-Maleimido-1- |
| | | | | | | | | | | | | phenyl |
| 34 | TMP | EtO | O | O | H | H | H | H | O | O | 3 | 4-Maleimido-1- |
| | | | | | | | | | | | | phenyl |
| 35 | TMP | EtO | O | O | H | H | H | H | O | O | 4 | 4-Maleimido-1- |
| | | | | | | | | | | | | phenyl |
| 36 | TMP | EtO | O | O | H | H | H | H | O | O | 5 | 4-Maleimido-1-phenyl |

As stated above, preference is also given to the-species from the table in which R² is 4-methylphenyl, 4-methoxyphenyl, 4-chlorophenyl, methoxy, n-propoxy, iso-propoxy, n-butoxy, sec-butoxy, iso-butoxy or tert-butoxy.

As stated above, preference is also given to the species from the table in which R¹ is ortho-substituted, for example

2,6-dimethyl-1-phenyl, 2,6-dimethoxy-1-phenyl,

2,6-dichloro-1-phenyl, 2-methylphenyl, 2-methoxyphenyl or

2-chlorophenyl.

Of the acyl- and bisacylphosphine derivatives described by the formula (IVe), particular preference is given to the following species IVe-1 to IVe-84, in which the radicals in the formula (IVe) have the following meanings:

| IVe- | R¹ | R² | Y | Z | R⁶ | R⁷ | R⁸ | R⁹ | Het¹ | Het² | n | R¹¹ | R¹² | R¹⁵ |
|---|---|---|---|---|---|---|---|---|---|---|---|---|---|---|
| 1 | TMP | Ph | O | O | H | H | H | H | O | O | 0 | H | H | Methyl |
| 2 | TMP | Ph | O | O | H | H | H | H | O | O | 1 | H | H | Methyl |
| 3 | TMP | Ph | O | O | H | H | H | H | O | O | 2 | H | H | Methyl |
| 4 | TMP | Ph | O | O | H | H | H | H | O | O | 3 | H | H | Methyl |
| 5 | TMP | Ph | O | O | H | H | H | H | O | O | 4 | H | H | Methyl |
| 6 | TMP | Ph | O | O | H | H | H | H | O | O | 5 | H | H | Methyl |
| 7 | TMP | Ph | O | O | H | H | H | H | O | O | 0 | H | H | Ethyl |
| 8 | TMP | Ph | O | O | H | H | H | H | O | O | 1 | H | H | Ethyl |
| 9 | TMP | Ph | O | O | H | H | H | H | O | O | 2 | H | H | Ethyl |
| 10 | TMP | Ph | O | O | H | H | H | H | O | O | 3 | H | H | Ethyl |
| 11 | TMP | Ph | O | O | H | H | H | H | O | O | 4 | H | H | Ethyl |
| 12 | TMP | Ph | O | O | H | H | H | H | O | O | 5 | H | H | Ethyl |
| 13 | TMP | Ph | O | O | H | H | H | H | O | O | 0 | H | H | n-Butyl |
| 14 | TMP | Ph | O | O | H | H | H | H | O | O | 1 | H | H | n-Butyl |
| 15 | TMP | Ph | O | O | H | H | H | H | O | O | 2 | H | H | n-Butyl |
| 16 | TMP | Ph | O | O | H | H | H | H | O | O | 3 | H | H | n-Butyl |
| 17 | TMP | Ph | O | O | H | H | H | H | O | O | 4 | H | H | n-Butyl |
| 18 | TMP | Ph | O | O | H | H | H | H | O | O | 5 | H | H | n-Butyl |
| 19 | TMP | Ph | O | O | H | H | H | H | O | O | 0 | H | H | 2-Acryloxy- |
| | | | | | | | | | | | | | | ethyl |
| 20 | TMP | Ph | O | O | H | H | H | H | O | O | 1 | H | H | 2-Acryloxy- |
| | | | | | | | | | | | | | | ethyl |
| 21 | TMP | Ph | O | O | H | H | H | H | O | O | 2 | H | H | 2-Acryloxy- |
| | | | | | | | | | | | | | | ethyl |
| 22 | TMP | Ph | O | O | H | H | H | H | O | O | 3 | H | H | 2-Acryloxy- |
| | | | | | | | | | | | | | | ethyl |
| 23 | TMP | Ph | O | O | H | H | H | H | O | O | 4 | H | H | 2-Acryloxy- |
| | | | | | | | | | | | | | | ethyl |
| 24 | TMP | Ph | O | O | H | H | H | H | O | O | 5 | H | H | 2-Acryloxy- |
| | | | | | | | | | | | | | | ethyl |
| 25 | TMP | Ph | O | O | H | H | H | H | O | O | 0 | H | H | 6-Acryloxy- |
| | | | | | | | | | | | | | | hexyl |
| 26 | TMP | Ph | O | O | H | H | H | H | O | O | 1 | H | H | 6-Acryloxy- |
| | | | | | | | | | | | | | | hexyl |
| 27 | TMP | Ph | O | O | H | H | H | H | O | O | 2 | H | H | 6-Acryloxy- |
| | | | | | | | | | | | | | | hexyl |
| 28 | TMP | Ph | O | O | H | H | H | H | O | O | 3 | H | H | 6-Acryloxy- |
| | | | | | | | | | | | | | | hexyl |
| 29 | TMP | Ph | O | O | H | H | H | H | O | O | 4 | H | H | 6-Acryloxy- |
| | | | | | | | | | | | | | | hexyl |
| 30 | TMP | Ph | O | O | H | H | H | H | O | O | 5 | H | H | 6-Acryloxy- |
| | | | | | | | | | | | | | | hexyl |
| 31 | TMP | Ph | O | O | H | H | H | H | O | O | 0 | H | H | 2,2-Bis (acryl- |
| | | | | | | | | | | | | | | oxymethyl) but- |
| | | | | | | | | | | | | | | 1-yl |
| 32 | TMP | Ph | O | O | H | H | H | H | O | O | 1 | H | H | 2,2-Bis (acryl- |
| | | | | | | | | | | | | | | oxymethyl) but- |
| | | | | | | | | | | | | | | 1-yl |
| 33 | TMP | Ph | O | O | H | H | H | H | O | O | 2 | H | H | 2,2-Bis (acryl- |
| | | | | | | | | | | | | | | oxymethyl) but- |
| | | | | | | | | | | | | | | 1-yl |
| 34 | TMP | Ph | O | O | H | H | H | H | O | O | 3 | H | H | 2,2-Bis (acryl- |
| | | | | | | | | | | | | | | oxymethyl) but- |
| | | | | | | | | | | | | | | 1-yl |
| 35 | TMP | Ph | O | O | H | H | H | H | O | O | 4 | H | H | 2,2-Bis (acryl- |
| | | | | | | | | | | | | | | oxymethyl) but- |
| | | | | | | | | | | | | | | 1-yl |
| 36 | TMP | Ph | O | O | H | H | H | H | O | O | 5 | H | H | 2,2-Bis (acryl- |
| | | | | | | | | | | | | | | oxymethyl) but- |
| | | | | | | | | | | | | | | 1-yl |
| 37 | TMP | Ph | O | O | H | H | H | H | O | O | 0 | H | H | 2,2,2-Tris |
| | | | | | | | | | | | | | | (acryloxy- |
| | | | | | | | | | | | | | | methyl) eth-1-yl |
| 38 | TMP | Ph | O | O | H | H | H | H | O | O | 1 | H | H | 2,2,2-Tris |
| | | | | | | | | | | | | | | (acryloxy- |
| | | | | | | | | | | | | | | methyl) eth-1-yl |
| 39 | TMP | Ph | O | O | H | H | H | H | O | O | 2 | H | H | 2,2,2-Tris |
| | | | | | | | | | | | | | | (acryloxy- |
| | | | | | | | | | | | | | | methyl) eth-1-yl |
| 40 | TMP | Ph | O | O | H | H | H | H | O | O | 3 | H | H | 2,2,2-Tris |
| | | | | | | | | | | | | | | (acryloxy- |
| | | | | | | | | | | | | | | methyl) eth-1-yl |
| 41 | TMP | Ph | O | O | H | H | H | H | O | O | 4 | H | H | 2,2,2-Tris |
| | | | | | | | | | | | | | | (acryloxy- |
| | | | | | | | | | | | | | | methyl) eth-1-yl |
| 42 | TMP | Ph | O | O | H | H | H | H | O | O | 5 | H | H | 2,2,2-Tris |
| | | | | | | | | | | | | | | (acryloxy- |
| | | | | | | | | | | | | | | methyl) eth-1-yl |
| 43 | TMP | EtO | O | O | H | H | H | H | O | O | 0 | H | H | Methyl |
| 44 | TMP | EtO | O | O | H | H | H | H | O | O | 1 | H | H | Methyl |
| 45 | TMP | EtO | O | O | H | H | H | H | O | O | 2 | H | H | Methyl |
| 46 | TMP | EtO | O | O | H | H | H | H | O | O | 3 | H | H | Methyl |
| 47 | TMP | EtO | O | O | H | H | H | H | O | O | 4 | H | H | Methyl |
| 48 | TMP | EtO | O | O | H | H | H | H | O | O | 5 | H | H | Methyl |
| 49 | TMP | EtO | O | O | H | H | H | H | O | O | 0 | H | H | Ethyl |
| 50 | TMP | EtO | O | O | H | H | H | H | O | O | 1 | H | H | Ethyl |
| 51 | TMP | EtO | O | O | H | H | H | H | O | O | 2 | H | H | Ethyl |
| 52 | TMP | EtO | O | O | H | H | H | H | O | O | 3 | H | H | Ethyl |
| 53 | TMP | EtO | O | O | H | H | H | H | O | O | 4 | H | H | Ethyl |
| 54 | TMP | EtO | O | O | H | H | H | H | O | O | 5 | H | H | Ethyl |
| 55 | TMP | EtO | O | O | H | H | H | H | O | O | 0 | H | H | n-Butyl |
| 56 | TMP | EtO | O | O | H | H | H | H | O | O | 1 | H | H | n-Butyl |
| 57 | TMP | EtO | O | O | H | H | H | H | O | O | 2 | H | H | n-Butyl |
| 58 | TMP | EtO | O | O | H | H | H | H | O | O | 3 | H | H | n-Butyl |
| 59 | TMP | EtO | O | O | H | H | H | H | O | O | 4 | H | H | n-Butyl |
| 60 | TMP | EtO | O | O | H | H | H | H | O | O | 5 | H | H | n-Butyl |
| 61 | TMP | EtO | O | O | H | H | H | H | O | O | 0 | H | H | 2-Acryloxy- |
| | | | | | | | | | | | | | | ethyl |
| 62 | TMP | EtO | O | O | H | H | H | H | O | O | 1 | H | H | 2-Acryloxy- |
| | | | | | | | | | | | | | | ethyl |
| 63 | TMP | EtO | O | O | H | H | H | H | O | O | 2 | H | H | 2-Acryloxy- |
| | | | | | | | | | | | | | | ethyl |
| 64 | TMP | EtO | O | O | H | H | H | H | O | O | 3 | H | H | 2-Acryloxy- |
| | | | | | | | | | | | | | | ethyl |
| 65 | TMP | EtO | O | O | H | H | H | H | O | O | 4 | H | H | 2-Acryloxy- |
| | | | | | | | | | | | | | | ethyl |
| 66 | TMP | EtO | O | O | H | H | H | H | O | O | 5 | H | H | 2-Acryloxy- |
| | | | | | | | | | | | | | | ethyl |
| 67 | TMP | EtO | O | O | H | H | H | H | O | O | 0 | H | H | 6-Acryloxy- |
| | | | | | | | | | | | | | | hexyl |
| 68 | TMP | EtO | O | O | H | H | H | H | O | O | 1 | H | H | 6-Acryloxy- |
| | | | | | | | | | | | | | | hexyl |
| 69 | TMP | EtO | O | O | H | H | H | H | O | O | 2 | H | H | 6-Acryloxy- |
| | | | | | | | | | | | | | | hexyl |
| 70 | TMP | EtO | O | O | H | H | H | H | O | O | 3 | H | H | 6-Acryloxy- |
| | | | | | | | | | | | | | | hexyl |
| 71 | TMP | EtO | O | O | H | H | H | H | O | O | 4 | H | H | 6-Acryloxy- |
| | | | | | | | | | | | | | | hexyl |
| 72 | TMP | EtO | O | O | H | H | H | H | O | O | 5 | H | H | 6-Acryloxy- |
| | | | | | | | | | | | | | | hexyl |
| 73 | TMP | EtO | O | O | H | H | H | H | O | O | 0 | H | H | 2,2-Bis (acryl- |
| | | | | | | | | | | | | | | oxymethyl) but- |
| | | | | | | | | | | | | | | 1-yl |
| 74 | TMP | EtO | O | O | H | H | H | H | O | O | 1 | H | H | 2,2-Bis (acryl- |
| | | | | | | | | | | | | | | oxymethyl) but- |
| | | | | | | | | | | | | | | 1-yl |
| 75 | TMP | EtO | O | O | H | H | H | H | O | O | 2 | H | H | 2,2-Bis (acryl- |
| | | | | | | | | | | | | | | oxymethyl) but- |
| | | | | | | | | | | | | | | 1-yl |
| 76 | TMP | EtO | O | O | H | H | H | H | O | O | 3 | H | H | 2,2-Bis (acryl- |
| | | | | | | | | | | | | | | oxymethyl) but- |
| | | | | | | | | | | | | | | 1-yl |
| 77 | TMP | EtO | O | O | H | H | H | H | O | O | 4 | H | H | 2,2-Bis (acryl- |
| | | | | | | | | | | | | | | oxymethyl) but- |
| | | | | | | | | | | | | | | 1-yl |
| 78 | TMP | EtO | O | O | H | H | H | H | O | O | 5 | H | H | 2,2-Bis (acryl- |
| | | | | | | | | | | | | | | oxymethyl) but- |
| | | | | | | | | | | | | | | 1-yl |
| 79 | TMP | EtO | O | O | H | H | H | H | O | O | 0 | H | H | 2,2,2-Tris |
| | | | | | | | | | | | | | | (acryloxy- |
| | | | | | | | | | | | | | | methyl) eth-1-yl |
| 80 | TMP | EtO | O | O | H | H | H | H | O | O | 1 | H | H | 2,2,2-Tris |
| | | | | | | | | | | | | | | (acryloxy- |
| | | | | | | | | | | | | | | methyl) eth-1-yl |
| 81 | TMP | EtO | O | O | H | H | H | H | O | O | 2 | H | H | 2,2,2-Tris |
| | | | | | | | | | | | | | | (acryloxy- |
| | | | | | | | | | | | | | | methyl) eth-1-yl |
| 82 | TMP | EtO | O | O | H | H | H | H | O | O | 3 | H | H | 2,2,2-Tris |
| | | | | | | | | | | | | | | (acryloxy- |
| | | | | | | | | | | | | | | methyl) eth-1-yl |
| 83 | TMP | EtO | O | O | H | H | H | H | O | O | 4 | H | H | 2,2,2-Tris |
| | | | | | | | | | | | | | | (acryloxy- |
| | | | | | | | | | | | | | | methyl) eth-1-yl |
| 84 | TMP | EtO | O | O | H | H | H | H | O | O | 5 | H | H | 2,2,2-Tris |
| | | | | | | | | | | | | | | (acryloxy- |
| | | | | | | | | | | | | | | methyl) eth-1-yl |

As stated above, preference is also given to the species from the table in which R² is 4-methylphenyl, 4-methoxyphenyl, 4-chlorophenyl, methoxy, n-propoxy, iso-propoxy, n-butoxy, sec-butoxy, iso-butoxy or tert-butoxy.

As stated above, preference is also given to the species from the table in which R¹ is ortho-substituted, for example

2,6-dimethyl-1-phenyl, 2,6-dimethoxy-1-phenyl,

2,6-dichloro-1-phenyl, 2-methylphenyl, 2-methoxyphenyl or

2-chlorophenyl.

The acyl- and bisacylphosphine derivatives of the formula (I) can also be prepared by reacting the corresponding compounds

H-Het¹-[(CR⁸R⁹)—(CR⁶R⁷)]ₙ-Het²-H

with the corresponding phosphine derivatives of the formula (V) which contain a leaving group FG, for example chloride, tosylate, mesylate, triflate or the like, bonded to the central phosphorus atom, as are described in the German application with the title “Acyl- and Bisacylphosphine Derivatives” and the file reference 102 06 117.3 with the application date Feb. 13, 2002.

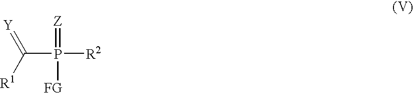

The phosphine derivatives of the formula (V) can be prepared by a process in which a substance of the formula (II) in which Het¹=O

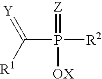

where R¹, R², Y and Z are as defined above, and

X is hydrogen or a cation,

is reacted with at least one agent which converts the —OX group into an —FG group.

Cations here can be, for example, those as listed in EP-A 62 839, i.e. equivalents of a cation from main group 1 to 3 of the Periodic Table having a molecular weight of less than 138, or ammonium ions derived from quaternary ammonium ions or triethylenediammonium ions.

Agents which convert the —OX group into the —FG group are known per se to the person skilled in the art. Examples which may be mentioned are phosgene (COCl₂), thionyl chloride (SOCl₂), sulfuryl chloride (SO₂Cl₂), phosphorus trichloride (PCl₃), phosphorus oxide trichloride (POCl₃), phosphorus pentachloride (PCl₅), oxalyl chloride ((COCl)₂), hydrogen chloride (HCl), chlorine gas (Cl₂), N-chloro compounds, for example N-chlorosuccinimide, alkali metal fluorides, cobalt(III) fluoride, halogen fluorides, antimony fluorides, molybdenum fluoride, hydrogen fluoride, hydrogen fluoride/pyridine mixtures, xenon fluorides and other noble-gas compounds, gaseous fluorine, sulfur tetrafluoride, iodine, iodine monochloride, phosphorus triiodide, acid iodides, N-iodosuccinimide, N-iodoacetamide, cyanogen chloride (ClCN), cyanuric chloride (2,4,6-trichloro-1,3,5-triazine, C₃Cl₃N₃), acid chlorides (R⁵(CO)Cl), esters or anhydrides (R⁵(CO)₂O), carbonic acid chlorides (R⁵O(CO)Cl), carbonates ((R⁵O)₂(CO)), sulfonic acid chlorides (R⁵SO₂Cl) or sulfonic anhydrides ((R⁵SO₂)₂O).

The compounds of the formula (IV) are obtainable analogously by reacting the Het²-substituted starting materials having free -Het¹-H groups with (V).

The compounds obtainable by these routes can likewise be used as photoinitiators which, so long as they contain polymerizable groups or reactive centers, can be additionally incorporated.

The photoinitiators according to the invention can of course also be used in the form of a mixture with other photoinitiators. These can be, for example, photoinitiators known to the person skilled in the art, for example those mentioned in “Advances in Polymer Science”, Volume 14, Springer Berlin, 1974, or in K. K. Dietliker, Chemistry and Technology of UV- and EB-Formulation for Coatings, Inks and Paints, Volume 3; Photoinitiators for Free Radical and Cationic Polymerization, P. K. T. Oldring (Eds), SITA Technology Ltd, London.

Suitable are, for example, mono- or bisacylphosphine oxides as described, for example, in EP-A 7 508, EP-A 57 474, DE-A 196 18 720, EP-A 495 751 or EP-A 615 980, for example

2,4,6-trimethylbenzoyldiphenylphosphine oxide (Lucirin® TPO, BASF AG), ethyl 2,4,6-trimethylbenzoylphenyl phosphinate (Lucirin® TPO L, BASF AG), bis(2,4,6-trimethylbenzoyl)phenylphosphine oxide (Irgacure® 819 from Ciba Spezialitatenchemie), benzophenones,

hydroxyacetophenones, phenylglyoxylic acid and derivatives thereof, or mixtures of these photoinitiators. Examples which may be mentioned are benzophenone, acetophenone, acetonaphthoquinone, methyl ethyl ketone, valerophenone, hexanophenone,

α-phenylbutyrophenone, p-morpholinopropiophenone,

dibenzosuberone, 4-morpholinobenzophenone,

4-morpholinodeoxybenzoin, p-diacetylbenzene, 4-aminobenzophenone,

4′-methoxyacetophenone, β-methylanthraquinone,

tert-butylanthraquinone, anthraquinonecarboxylic acid esters,

benzaldehyde, α-tetralone, 9-acetylphenanthrene,

2-acetylphenanthrene, 10-thioxanthenone, 3-acetylphenanthrene,

3-acetylindole, 9-fluorenone, 1-indanone, 1,3,4-triacetylbenzene,

thioxanthen-9-one, xanthen-9-one, 2,4-dimethylthioxanthone,

2,4-diethylthioxanthone, 2,4-di-iso-propylthioxanthone,

2,4-dichlorothioxanthone, benzoin, benzoin iso-butyl ether,

chloroxanthenone, benzoin tetrahydropyranyl ether, benzoin methyl

ether, benzoin ethyl ether, benzoin butyl ether, benzoin

iso-propyl ether, 7H-benzoin methyl ether,

benz[de]anthracen-7-one, 1-naphthaldehyde,

4,4′-bis(dimethylamino)benzophenone, 4-phenylbenzophenone,

4-chlorobenzophenone, Michler's ketone, 1-acetonaphthone,

2-acetonaphthone, 1-benzoylcyclohexan-1-ol,

2-hydroxy-2,2-dimethylacetophenone,

2,2-dimethoxy-2-phenylacetophenone,

2,2-diethoxy-2-phenylacetophenone, 1,1-dichloroacetophenone,

1-hydroxyacetophenone, acetophenone dimethyl ketal,

o-methoxybenzophenone, triphenylphosphine, tri-o-tolylphosphine,

benz[a]anthracene-7,12-dione, 2,2-diethoxyacetophenone, benzil ketals, such as benzil dimethyl ketal,

2-methyl-1-[4-(methylthio)phenyl]-2-morpholinopropan-1-one, anthraquinones, such as 2-methylanthraquinone,

2-ethylanthraquinone, 2-tert-butylanthraquinone,

1-chloroanthraquinone, 2-amylanthraquinone and 2,3-butanedione.

Also suitable are photoinitiators of the phenylglyoxalic acid ester type which have little or no tendency toward yellowing, as described in DE-A 198 26 712, DE-A 199 13 353 or WO 98/33761.

The compounds of the formulae (I) and (IV) according to the invention react or interact, after mixing with the radiation-curable composition, with the reactive centers or polar groups thereof and are thus bound in a migration-resistant manner.

The coating compositions prepared with the incorporable photoinitiators according to the invention are particularly suitable for use in packaging systems, particularly preferably in the foods sector.

Using the compounds according to the invention, it is possible to improve the interactions with the radiation-curable surface-coating systems and thus to optimize the solubility, miscibility, homogenization, etc. It is thus possible, by means of the alkoxylated products according to the invention, to improve the solubility of the photoinitiators in polyetherol acrylates, which was not possible with conventional acylphosphine oxides.

Suitable radiation-curable compositions are, for example, those which have, per 100 g of substance, from 0.01 to 1.4 mol, preferably from 0.05 to 1.25 mol, particularly preferably from 0.1 to 1 mol, very particularly preferably from 0.2 to 0.75 mol, of reactive centers and/or from 0.01 to 1.25 mol, preferably from 0.05 to 1.15 mol, particularly preferably from 0.1 to 1 mol, very particularly preferably from 0.2 to 0.75 mol, of polar groups.

Preference is given to radiation-curable compositions which have from 0.01 to 1.25 mol, preferably from 0.05 to 1.15 mol, particularly preferably from 0.1 to 1 mol, very particularly preferably from 0.2 to 0.75 mol, of hydroxyl groups per 100 g of substance and/or from.0.01 to 0.75 mol, preferably from 0.05 to 0.66 mol, particularly preferably from 0.1 to 0.5 mol, of isocyanate groups per 100 g of substance and/or from 0.01 to 1.4 mol, preferably from 0.05 to 1.25 mol, particularly preferably from 0.1 to 1 mol, very particularly preferably from 0.2 to 0.75 mol, of epoxide groups per 100 g of substance and/or from 0.01 to 1.4 mol, preferably from 0.05 to 1.25 mol, particularly preferably from 0.1 to 1 mol, very particularly preferably from 0.2 to 0.75 mol, of α,β-unsaturated carbonyl groups per 100 g of substance.

The bonding of the compounds of the formulae (I) and (IV) according to the invention to the reactive centers or polar groups is generally carried out at a temperature between room temperature and the curing temperature of the radiation-curable composition. Typical temperatures are 40-120° C., preferably 50-110° C. and particularly preferably 60-100° C.

In the course of the curing or bonding process, the temperature can be kept constant or increased.

The duration of the thermal treatment is generally between a few minutes and several hours, for example from 1 minute to 5 hours, preferably from 2 minutes to 3 hours, particularly preferably from 5 minutes to 2 hours and in particular from 10 minutes to 1 hour.

The invention accordingly also relates to radiation-curable compositions which are obtainable by reaction of at least one substance of the formula (I) or (IV) or a substance prepared by a process according to the invention with a radiation-curable composition containing reactive centers and/or polar groups.

The invention accordingly further relates to radiation-curable compositions comprising a photoinitiator according to the invention.

Radiation-curable compositions typically comprise

(A) at least one polymerizable compound having one or more copolymerizable, ethylenically unsaturated groups,

(B) if desired reactive thinners,

(C) at least one photoinitiator according to the invention and, if desired, at least one further photoinitiator known per se, and

(D) if desired further additives which are typical in surface coatings.

Typical compositions are, for example,

(A) 40-100% by weight, preferably 50-90% by weight, particularly preferably 60-90% by weight and in particular 60-80% by weight,

(B) 0-60% by weight, preferably 5-50% by weight, particularly preferably 6-40% by weight and in particular 10-30% by weight,

(C) 0.1-20% by weight, preferably 0.5-15% by weight, particularly preferably 1-10% by weight and in particular 2-5% by weight, and

(D) 0-50% by weight, preferably 2-40% by weight, particularly preferably 3-30% by weight and in particular 5-20% by weight,

with the proviso that the sum is always 100% by weight.

In specific applications, the proportion of additives (D) which are typical in surface coatings can be up to 90% by weight. In this case, the proportions of the other components are reduced correspondingly.

Compounds (A) can be, for example, the urethane, melamine, polyesterol, polyetherol, epoxide or carbonate acrylates, methacrylates or vinyl ethers mentioned above.

Preferred compounds (A) are vinyl ether or (meth)acrylate compounds, particular preference being given in each case to the acrylate compounds, i.e. the derivatives of acrylic acid.

Preferred vinyl ether and (meth)acrylate compounds (A) contain from 2 to 20, preferably from 2 to 10 and very particularly preferably from 2 to 6 copolymerizable, ethylenically unsaturated double bonds.

Particular preference is given to compounds (A) having a content of ethylenically unsaturated double bonds of 0.1-0.7 mol/100 g, very particularly preferably 0.2-0.6 mol/100 g.

Suitable reactive thinners (compounds (B)) are free-radical-polymerizable compounds, preferably radiation-curable compounds containing an ethylenically unsaturated, copolymerizable group, or mixtures thereof.

Mention may be made, for example, of 60 ,β-unsaturated carboxylic acids, C₁-C₂₀-alkyl (meth)acrylates, vinylaromatic compounds having up to 20 carbon atoms, vinyl esters of carboxylic acids containing up to 20 carbon atoms, ethylenically unsaturated nitriles, vinyl ethers of alcohols containing from 1 to 10 carbon atoms, and aliphatic hydrocarbons having from.2 to 8 carbon atoms and one or two double bonds.

For the purposes of this specification, the term (meth)acrylic acid is used for acrylic acid and methacrylic acid.

α,β-Unsaturated carboxylic acids which can be used are, for example, acrylic acid, methacrylic acid, maleic acid or monoesters thereof, 3-acryloxypropionic acid, maleic anhydride, fumaric acid or monoesters thereof, or crotonic acid.

Preferred alkyl (meth)acrylates are those containing a C₁-C₁₀-alkyl radical, such as methyl methacrylate, methyl acrylate and ethyl acrylate.

Mixtures of the alkyl (meth)acrylates are also particularly suitable.

Vinyl esters of carboxylic acids having from 1 to 20 carbon atoms are, for example, vinyl laurate, vinyl stearate, vinyl propionate and vinyl acetate.

Suitable vinylaromatic compounds are, for example, vinyltoluene, α-butylstyrene, 4-n-butylstyrene, 4-n-decylstyrene and preferably styrene.

Examples of nitriles are acrylonitrile and methacrylonitrile.

Examples of suitable vinyl ethers are vinyl methyl ether, vinyl isobutyl ether, vinyl hexyl ether and vinyl octyl ether.

Non-aromatic hydrocarbons having from 2 to 8 carbon atoms and one or two olefinic double bonds which may be mentioned are butadiene, isoprene, as well as ethylene, propylene and isobutylene.

It is also possible to employ N-vinylformamide, N-vinylpyrrolidone and N-vinylcaprolactam.

The additives (D) which are typical in surface coatings can be, for example, antioxidants, oxidation inhibitors, stabilizers, activators (accelerators), fillers, pigments, dyes, degassing agents, luster agents, antistatic agents, flame inhibitors, thickeners, thixotropic agents, flow-control agents, binders, antifoaming agents, fragrances, surface-active agents, viscosity modifiers, plasticizers, tackifying resins (tackifiers), chelating agents or compatibilizers.

The coating of substrates with the radiation-curable compositions according to the invention is carried out by conventional methods known to the person skilled in the art, in which at least one radiation-curable composition according to the invention, for example in the form of a dispersion or alternatively without a solvent, is applied in the desired thickness to the substrate to be coated, and the volatile constituents of the dispersion are removed, if necessary with heating. This operation can, if desired, be repeated one or more times.

The application to the substrate can be carried out in a known manner, for example by spraying, dipping, knife coating, using an air blade, brushing, rolling or curtain coating. The coating thickness is generally in the range from about 3 to 1000 g/m² and preferably from 10 to 200 g/m².

Also disclosed is a process for the coating of substrates in which a coating composition comprising a compound according to the invention, if desired as a surface-coating formulation to which further additives which are typical in surface coatings and/or thermally curable resins have been added, is applied to the substrate, if desired dried, thermally treated at the curing temperature indicated above, and subsequently cured, if desired at temperatures up to the level of the curing temperature, with active radiation under an oxygen-containing atmosphere, for example air, or preferably under an inert gas.

The process for the coating of substrates can also be carried out by, after application of the mixture or surface-coating formulation according to the invention, firstly effecting curing with active radiation under an oxygen-containing atmosphere, for example air, or preferably under an inert gas, and subsequently carrying out a thermal treatment at the curing temperature.

Thermal and radiation curing can of course also be carried out in parallel.

The curing of the films formed on the substrate can, if desired, be carried out exclusively thermally. In general, however, the coatings are cured both by irradiation with high-energy radiation and also thermally.

If desired, if a plurality of layers of the coating composition are applied one on top of the other, thermal and/or radiation curing can be carried out after each coating operation.

Examples of active energy rays are ultraviolet rays, X-rays and electron beams, preferably ultraviolet rays and electron beams.

The coating of substrates can also be carried out as follows:

i) a substrate is coated with a mixture according to the invention, as described above,

ii) volatile constituents of the mixture according to the invention are removed for film formation under conditions under which the initiator (C) essentially still forms no free radicals,

iii) if desired, the film formed in step ii) is irradiated with high-energy radiation, during which the film is pre-cured, and the article coated with the pre-cured film is, if desired, subsequently treated mechanically or the surface of the pre-cured film is brought into contact with another substrate,

iv) the film is thermally cured to completion.

Steps iv) and iii) can also be carried out in the reverse 40 sequence, i.e. the film can firstly be cured thermally and then with high-energy radiation.

Typical curing temperatures are 40-120° C., preferably 50-110° C. and particularly preferably 60-100° C.

In the course of the curing process, the temperature can be kept constant or increased.

The curing duration is generally between a few minutes and several hours, for example from 1 minute to 5 hours, preferably from 2 minutes to 3 hours, particularly preferably from 5 minutes to 2 hours and in particular from 10 minutes to 1 hour.

Suitable radiation sources for the radiation curing are, for example, mercury low-pressure emitters, medium-pressure emitters or high-pressure emitters and fluorescent tubes, pulsed emitters, metal-halide emitters, xenon lamps, electrode-less discharge lamps, carbon arc lamps, electronic flash devices, which enable radiation curing without a photoinitiator, or excimer emitters. The radiation curing is carried out through exposure to high-energy radiation, i.e. UV radiation or daylight, preferably light having a wavelength in the range from λ=150 to 700 nm, particularly preferably from λ=200 to 500 nm and very particularly preferably from λ=250 to 400 nm, or by irradiation with high-energy electrons (electron beam; from 50 to 1000 keV, preferably from 100 to 500 keV and particularly preferably from 150 to 300 keV) using devices of, for example, the Cockroft-Walton type, van de Graaff type or resonance type. The radiation sources used are, for example, high-pressure mercury vapor lamps, lasers, pulsed lamps (flashlight), halogen lamps or excimer emitters. The radiation dose which is usually sufficient for crosslinking in the case of UV curing is in the range from 80 to 3000 mJ/cm².

It is of course also possible to employ a plurality of radiation sources for the curing, for example from two to four.

These can also emit in different wavelength ranges.

Since the chromophore of the acylphosphine oxide has an absorption band in the visible wavelength range above 400 nm, the photoinitiators according to the invention can also be employed with a radiation source having a low or even no UV content. Daylight curing is likewise possible, albeit generally slower than curing with active energy radiation.

The irradiation can, if desired, also be carried out with exclusion of oxygen, for example under an inert-gas atmosphere. Suitable inert gases are preferably nitrogen, noble gases, carbon dioxide, or combustion gases. The irradiation can furthermore be carried out by masking the coating composition with transparent media. Transparent media are, for example, plastic films, glass or liquids, for example water. Irradiation is particularly preferably carried out in the manner as described in DE-A 199 57 900.

The following examples are intended to explain the invention, but without representing a restriction thereto.

### EXAMPLES

“Parts” here are taken to mean “parts by weight”, unless specified otherwise.

### Example 1

### Trimethylbenzoylphenylphosphinic Acid Sodium Salt

644 g of ethyl trimethylbenzoylphenylphosphinate (Lucirin® TPO-L, BASF AG) were initially introduced in 3000 ml of ethyl methyl ketone. 1.1 equivalents (285 g) of sodium iodide was added to the solution. After 15 minutes, the homogeneous solution was heated to 65° C. and stirred for 24 hours. The yellow precipitate was filtered off with suction and washed with 2×500 ml of petroleum ether. The filter cake was dried at 60° C. under reduced pressure. 530 g (85% of theory) of pale-yellow powder were isolated.

31P-NMR (d₆-DMSO): δ (ppm)=10.8 1H-NMR (d₆-DMSO): δ (ppm)=2.2 (s, 6H), 2.25 (s, 3H), 6.6 (s, 2H), 7.3 (m, 3H), 7.6 (m, 2H)

### Example 2

### Trimethylbenzoylphenylphosphinic Acid

401.55 g of the sodium salt from Example 1 were dissolved in 1500 ml of water acidified to pH 1 with 1300 ml of 0.5 molar sulfuric acid. After 1 hour, the crystal batch which had precipitated was filtered off with suction, washed twice with 700 ml of water each time and sucked dry. The filter cake was dried azeotropically with 1500 ml of toluene in a water separator. The clear, pale-yellow toluene solution was evaporated at 50° C., and the acid was recrystallized from 2150 ml of ethyl acetate. The crystals were filtered off with suction at 0°, washed with ethyl acetate and dried at 60° C. under reduced pressure.

Weight: 300 g (80% of theory) of pale-yellow crystals. 1P-NMR (d₆-DMSO): δ (ppm)=17.4 1H-NMR (d₆-DMSO): δ (ppm)=2.1 (s, 6H), 2.3 (s, 3H), 6.7 (s, 2H) 7.35 (m, 2H), 7.6 (m, 1H), 7.75 (m, 2H)

### Example 3

### Reaction of Trimethylbenzoylphenylphosphinic Acid with Ethylene Oxide

144 g of the acid from Example 2 were dissolved in 500 ml of toluene at 60° C., and a solution, cooled to −20° C., of 48 g of ethylene oxide in 50 ml of toluene was added over the course of 90 minutes. After post-reaction at 60° C. for 1 hour, acid was no longer evident in the thin-layer chromatogram. The solution was evaporated, filtered to remove the cloudiness and dried. 172 g of reaction product were isolated as a uniform product in quantitative yield.

Elemental analysis: 66.5% C, 6.6% H, 9.1% P,

### Example 4

### Reaction of Trimethylbenzoylphenylphosphinic Acid with Propylene Oxide

28.8 g of the acid from Example 2 were dissolved in 100 ml of toluene at 60° C., and a solution, cooled to −20° C., of 15.9 g of propylene oxide in 50 ml of toluene was added over the course of minutes. After post-reaction at 60° C. for 1 hour, acid was no longer evident in the thin-layer chromatogram. The solution was evaporated, taken up in diethyl ether, filtered to remove the cloudiness and dried.

34.5 g of 2-hydroxy-2-isobutyl trimethylbenzoylphenylphosphinate were isolated as a uniform product, yield quantitative.

Elemental analysis: 67.1% C, 6.8% H, 8.9% P,

### Example 5

### Reaction of Trimethylbenzoylphenylphosphinic Acid with Iso-Butylene Oxide

b 14.4 g of the acid from Example 2 were dissolved in 50 ml of toluene at 60° C., and a solution of 7.8 g of iso-butylene oxide in 25 ml of toluene was added over the course of 45 minutes. After post-reaction at 60° C. for 1 hour, acid was no longer evident in the thin-layer chromatogram. The solution was evaporated, taken up in diethyl ether, filtered to remove the cloudiness and dried.

5 17.6 g of 2-hydroxy-2-isobutyl trimethylbenzoylphenylphosphinate were isolated as a uniform product, yield 98% of theory.

### Example 6

### Reaction of the Hydroxyethylated Compound with Maleic Anhydride

A total of 7.41 g of maleic anhydride were added in portions to 19.9 g of the reaction product from Example 3.

After 4 hours at 85° C., the starting material had reacted completely. Work-up gave 24.5 g (95% of theory) of NMR-uniform product.

### Example 7

### Reaction of the Hydroxyethylated Compound with Tolylene 2,4-diisocyanate (TDI)

4.5 g of tolylene diisocyanate (TDI, 0.5 mol-equivalent) were added to 16.5 g of the reaction product from Example 3, 20 mg of dibutyltin dilaurate and 20 ml of ethyl acetate, and the mixture was stirred at 70° C. for 4 hours. Evaporation under reduced pressure left 19.8 g of uniform diaddition product, yield 88% of theory.

Elemental analysis: 63.9% C, 5.9% N, 3.6% H, 6.6% P,

### Example 8

Reaction of the Hydroxyethylated Compound with Hexamethylene 1,6-diisocyanate (HDI)

A total of 4.81 g of hexamethylene diisocyanate (HDI, 0.5 mol-equivalent) were added in portions to 16.6 g of hydroxyethyl trimethylbenzoylphenylphosphinate from Example 3, 20 mg of dibutyltin dilaurate and 20 ml of ethyl acetate, and the mixture was stirred at 70° C. for a total of 8 hours. Evaporation under reduced pressure left 23.2 g of uniform diaddition product, yield quantitative.

Elemental analysis: 61.9% C, 6.6% H, 3.4% N, 6.5% P,

### Example 9

### Reaction of the Hydroxyethylated Compound with Isophoronediamine diisocyanate

9.96 g of hydroxyethyl trimethylbenzoylphenylphosphinate from Example 3 were dissolved in 30 ml of toluene and stirred at 70° C. for 4 hours with 6.66 g of isophoronediamine diisocyanate (1 mol-equivalent). Evaporation under reduced pressure left 16.9 g of uniform monoaddition product, yield quantitative.

Elemental analysis: 65.1% C, 7.03% H, 5.1% N, 5.3% P,

### Example 10

### Partial Hydrolysis of the Monoisocyanate from Example 9

A solution of 16.6 g of the monoisocyanate from Example 9 in 20 ml of THF was added to a mixture of 110 ml of 5% hydrochloric acid and 100 ml of THF, and the mixture was stirred at 20° C. for 3 days and at 40° C. for 15 hours. 1 1 of water was added to the reaction mixture, which was rendered slightly alkaline (pH 8-9). The mixture was extracted twice with 200 ml of methylene chloride each time, dried and evaporated, leaving 11.6 g of uniform product (73% of theory).

Elemental analysis: 63.9% C, 7.5% H, 4.8% N, 5.2% P,

We claim:

1. An acyl- or bisacylphosphine derivative of the formula (I) 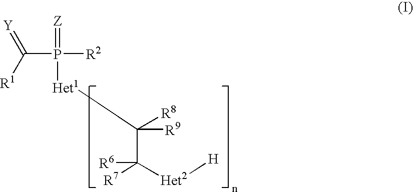
where
R¹ and R² are C₁-C₁₈-alkyl, or C₂-C₁₈-alkyl, C₂-C₁₈-alkenyl, C₆-C₁₂-aryl or C₅-C₁₂-cycloalkyl, each of which is uninterrupted or interrupted by one or more oxygen and/or sulfur atoms and/or one or more substituted or unsubstituted imino groups, or are a five- to six-membered, oxygen, nitrogen and/or sulfur atom-containing heterocyclic radical, where the said radicals may each be substituted by aryl, alkyl, aryloxy, alkoxy, heteroatoms and/or heterocyclic radicals,
R² is furthermore C₁-C₁₈-alkoxy, which is unsubstituted or substituted by aryl, alkyl, aryloxy, alkoxy, heteroatoms and/or heterocyclic radicals, or is R¹—(C═Y)—,
Y is O, S , NR³, N—OR³ or N—NR³R⁴,
z is O, S , NR³, N—OR³, N—NR³R⁴ or a free pair of electrons,
R³ is hydrogen, C₁- to C₄-alkyl, SO₃H, phenyl or acetyl,
R⁴ is hydrogen, C₁- to C₄-alkyl, COOR³, or C₆-C₁₂-aryl or arylsulfonyl, each of which is unsubstituted or
substituted by aryl, alkyl, aryloxy, alkoxy, heteroatoms and/or heterocyclic radicals,
Het¹ and Het², independently of one another, are O, S and/or NR⁵,
R⁵ is hydrogen, C₁-C₁₈-alkyl, which is unsubstituted or substituted by aryl, alkyl, aryloxy, alkoxy, heteroatoms and/or heterocyclic radicals, or C₆-C₁₂-aryl, which is unsubstituted or substituted by aryl, alkyl, aryloxy, alkoxy, heteroatoms and/or heterocyclic radicals,
R⁶, R⁷, R⁸ and R⁹, independently of one another, are hydrogen, C₁-C₁₈-alkyl, which is unsubstituted or substituted by aryl, alkyl, aryloxy, alkoxy, heteroatoms and/or heterocyclic radicals, C₂-C₁₈-alkenyl, which is unsubstituted or substituted by aryl, alkyl, aryloxy, alkoxy, heteroatoms and/or heterocyclic radicals, or C₆-C₁₂-aryl, which is unsubstituted or substituted by aryl, alkyl, aryloxy, alkoxy, heteroatoms and/or heterocyclic radicals, and
n is an integer from 1 to 100.

2. An acyl- or bisacylphosphine derivative as claimed in claim 1, where
Y is O, S or NR³,
Z is O, S, NR³ or a free pair of electrons,
Het¹is O or NR⁵,
Het² is O or NR⁵,
of the radicals R⁶, R⁷, R⁸ and R⁹, two are hydrogen and two are hydrogen, methyl, phenyl and/or vinyl, and
n is an integer from 1 to 50.

3. An acyl- or bisacylphosphine derivative as claimed in claim 1, where
Y is O or S,
Z is O, S or a free pair of electrons,
Het¹ is O,
Het² is O or NR⁵,
of the radicals R⁶, R⁷, R⁸ and R⁹, three are hydrogen and one is hydrogen or methyl, and
n is an integer from 1 to 40.

4. An acyl- or bisacylphosphine derivative as claimed in claim 1, where
Y is O,
Z is O or a free pair of electrons,
Het¹ is O,
Het² is O,
R⁶, R⁷, R⁸ and R⁹ are hydrogen, and
n is an integer from 1 to 20.

5. An acyl- or bisacylphosphine derivative as claimed in any one of claims 1 to 4, where
R¹ is 2,4,6-trimethylphenyl, 2,6-dimethylphenyl, 2,6-dimethoxyphenyl, 2,6-dichlorophenyl, 2,4,6-trichlorophenyl or phenyl, and
R² is phenyl or ethoxy.

6. A process for the preparation of a substance of the formula (I) as claimed in any one of claims 1 to 5, which comprises reacting a substance of the formula (II) 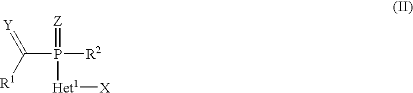
where R¹, R², Y, Z and Het¹ are as defined in claim 1, and
X is hydrogen or a cation,
with at least one alkylene oxide, aziridine or thiirane of the formula (III) 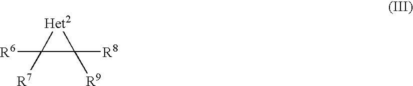
where Het², R⁶, R⁷, R⁸ and R⁹ are as defined in claim 1.

7. A process as claimed in claim 6, wherein
Het² is O or NR⁵,
X is hydrogen or a cation, and
of the radicals R⁶, R⁷, R⁸ and R⁹, three are hydrogen and one is hydrogen, methyl, phenyl or vinyl.

8. A process as claimed in claim 6, wherein
Het² is O,
X is hydrogen or a cation, and
of the radicals R⁶, R⁷, R⁸ and R⁹, three are hydrogen and one is hydrogen or methyl.

9. A compound obtainable by reaction of an acyl- or bisacylphosphine derivative as claimed in any one of claims 1 to 5 with a radiation-curable composition which contains at least one polar group and/or at least one reactive center which is/are able to interact with the -Het²-H group of the compounds of the formula (I) from claims 1 to 5.

10. A compound as claimed in claim 9, wherein the radiation-curable composition contains, as reactive center, at least one isocyanate group, at least one α,β-unsaturated carboxyl or carboxylate group, at least one epoxide group or at least one α,β-unsaturated carbonyl group.

11. An acyl- or bisacylphosphine derivative of the formula (IVa) 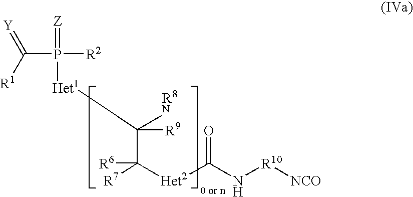
where R¹, R², R⁶, R⁷, R⁸, R⁹, Y, Z, Het¹ and Het² are as defined in claim 1, and
R¹⁰ is 1,2-ethylene, 1,4-butylene, 1,6-hexylene, 1,2-, 1,3-or 1,4-cyclohexylene,
1,3,3-trimethyl-1,5-cyclohexylene,
1-methyl-2,4-phenylene, 1-methyl-2,6-phenylene,
4,4′-diphenylmethylene, 2,4′-diphenylmethylene or
2′,4-diphenylmethylene.

12. An acyl- or bisacylphosphine derivative of the formula (IVb) 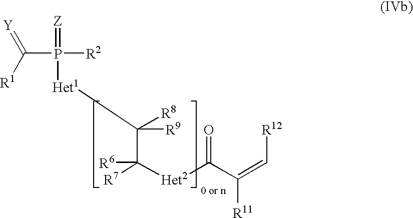
where R¹, R², R⁶, R⁷, R⁸, R⁹, Y, Z, Het¹ and Het² are as defined in claim 1,
R¹¹ is hydrogen or methyl, and
R¹² is hydrogen, E- or Z-methyl, -ethyl, -methoxycarbonyl,
-ethoxycarbonyl, -n-butoxycarbonyl or
-2-ethylhexyloxycarbonyl.

13. An acyl- or bisacylphosphine derivative of the formula (IVc) 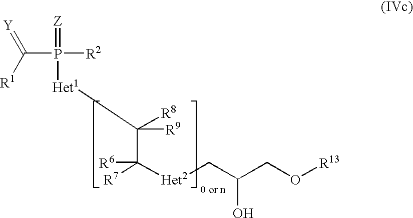
where R¹, R², R⁶, R⁷, R⁸, R⁹, Y, Z, Het¹ and Het² are as defined in claim 1, and
R¹³ is hydrogen, methyl, ethyl, n-butyl, 2-ethylhexyl,
n-octyl, 1-isopropylidene-4′-hydroxyphenylphen-4-yl,
1-methylene-4′-hydroxyphenylphen-4-yl,
1-isopropylidene-4′-[(2″,3″-epoxyprop-1″-yloxy)phenyl]phen-4-yl,
1-methylene-4′-[(2″,3″-epoxyprop-11′-′-yloxy)phenyl]phen-4-yl,
1-isopropylidene-4′-hydroxycyclohexylcyclohex-4-yl or 1-methylene-4′-hydroxycyclohexylcyclohex-4-yl.

14. An acyl- or bisacylphosphine derivative of the formula (IVd) 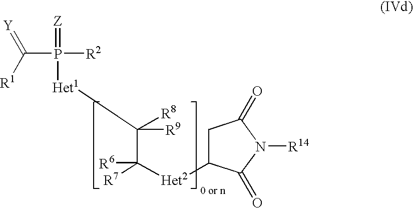
where R¹, R², R⁶, R⁷, R⁸, R⁹, Y, Z, Het¹ and Het² are as defined in claim 1, and
R¹⁴ is hydrogen, methyl, ethyl, iso-propyl, n-propyl,
n-butyl, iso-butyl, sec-butyl, tert-butyl, 2-ethylhexyl,
n-octyl, 2-maleimidoethyl, 3-maleimidopropyl,
6-maleimidohexyl, 4-maleimidophenyl,
4-(4′-maleimidophenyl)phenyl,
4-(4′-maleimidophenoxy)phenyl,
1-methylene-(4′-maleimidophenyl)phen-4-yl or
1-isopropylidene-(4′-maleimidophenyl)phen-4-yl.

15. An acyl- or bisacylphosphine derivative of the formula (IVe) 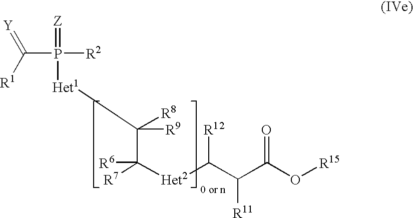
where R¹, R², R⁶, R⁷, R⁸, R⁹, Y, Z, Het¹ and Het² are as defined in claim 1,
R¹¹ is hydrogen or methyl,
R¹² is hydrogen, methyl, ethyl, methoxycarbonyl,
ethoxycarbonyl, n-butoxycarbonyl or
2-ethylhexyloxycarbonyl, and
R¹⁵ is hydrogen, methyl, ethyl, iso-propyl, n-propyl,
n-butyl, iso-butyl, sec-butyl, tert-butyl, 2-ethylhexyl,
n-octyl, 2-dimethylaminoethyl, 2-(meth)acryloxyethyl,
3-(meth)acryloxypropyl,
2,2-dimethyl-3-(meth)acryloxypropyl,
4-(meth)acryloxybutyl, 6-(meth)acryloxyhexyl,
2,2-di[(meth)acryloxymethyl]but-1-yl or
2,2,2-tri[(meth)acryloxymethyl]eth-1-yl.

16. An acyl- or bisacylphosphine derivative of the formula (IVf) 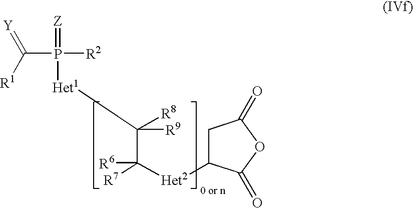
where R¹, R², R⁶, R⁷, R⁸, R⁹, Y, Z, Het¹ and Het² are as defined in claim 1.

17. An acyl- or bisacylphosphine derivative of the formula (IVg) 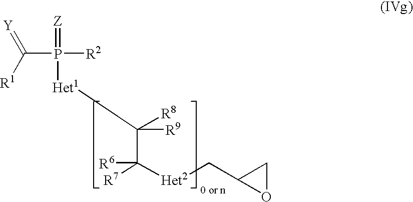
where R¹, R², R⁶, R⁷, R⁸, R⁹, Y, Z, Het¹ and Het² are as defined in claim 1.

18. The use of a substance as claimed in any one of claims 1 to 5 or 11 to 17 as photoinitiator.

19. The use of a substance as claimed in any one of claims 1 to 5 or 11 to 17 in the synthesis of photoinitiators.

20. A photoinitiator mixture comprising a substance as claimed in any one of claims 1 to 5 or 11 to 17.

21. A radiation-curable composition comprising a substance as claimed in any one of claims 1 to 5 or 11 to 17 or a photoinitiator mixture as claimed in claim 20.
